(19) United States
(12) Patent Application Publication
(10) Pub. No.: US 2019/0046307 A1
(43) Pub. Date: Feb. 14, 2019

(54) Provisional Dental Restoration

(71) Applicant: Cagenix, Inc., Memphis, TN (US)

(72) Inventors: Drew Schulter, Memphis, TN (US); Carl Schulter, Germantown, TN (US); Kyle Fraysur, Cordova, TN (US); Daryl Newman, Williston, TN (US); Belal Hamadeh, Memphis, TN (US)

(73) Assignee: Cagenix, Inc., Memphis, TN (US)

(21) Appl. No.: 15/672,074

(22) Filed: Aug. 8, 2017

(51) Int. Cl. A61C 13/097; A61C 5/77; A61C 13/00

(52) U.S. Cl. CPC A61C 13/097; A61C 13/20; A61C 13/0004; A61C 5/77

(57) ABSTRACT

The present disclosure reveals a provisional dental restoration for use at the time of dental implant surgery and while the permanent long-term restoration is being fabricated and implants are healing, which aids in the surgical process and selection of potential abutments at the time of surgery. Also revealed is a new digitally designed impression prosthesis from which the doctor is able of capturing the occlusal record, an impression of the soft tissue and critical aspects of the tooth position and orientation in a single procedure.

### CROSS-REFERENCE TO RELATED APPLICATIONS

Ser. No. 15/068,423 March 2016 Schulter, et al.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### DESCRIPTION

### Field of the Invention

Providing a provisional restoration or interim prosthesis at the time of dental implant surgery aids in the healing process and provides the patient with a functioning temporary restoration while the permanent long-term restoration is being fabricated and implants are healing. Currently, during the process of a full mouth restoration, doctors are utilizing a traditional denture that is altered to seat on the implants placed in the patient's mouth as the provisional restoration. The use of this traditional denture typically leads to breakage and repair scenarios for the patient and the doctor. These breakage and repair scenarios typically occur due to the acrylic and denture teeth materials breaking in the areas modified by the doctor to retrofit the traditional denture to the implants. A need exists for an improved process and product that alleviates these costly breakage and repair scenarios for the doctor and patient which is the purpose of this disclosure. The doctor would also benefit from a process for the creation of a provisional restoration and the associated provisional restoration that can aid in the surgical process and selection of potential abutments at the time of surgery.

In addition to an improved restoration, there is a need for an improved impression and diagnostic process that alleviates the number of visits for the patient and doctor. The traditional procedure of impressing, fabricating a verification jig, wax bite rim and diagnostic wax up can be tedious, lengthy, frustrating, time consuming, and costly to both the doctor and the patient. Utilizing a new digitally designed impression prosthesis, the doctor is able to capture the occlusal record, an impression of the soft tissue, and critical aspects of the tooth position and orientation in a single procedure. A new process that can aid both the patient and the doctor in expediting the delivery of the final prosthesis and provide improved accuracy over the current process is crucial.

### Background of the Invention

Doctors will often provide a temporary restoration at the time of surgery to aid in the healing and osseointegration of the patient's dental implants. The patient also benefits with having a temporary restorative solution while the long-term prosthesis is being created and implants are healing. Typically, these temporary restorations will remain in the patient's mouth for a period of 3 to 6 months or until appropriate healing and osseointegration has been achieved.

The current state of the art in the making of the temporary restoration is utilizing a traditional denture that is retrofitted to seat on the implants and/or abutments in the patient's mouth. The traditional denture that is retrofitted utilizes a pink acrylic base plate and denture teeth common in the market and can be fabricated from a number of methods (heat cured acrylic, cold cure, light cure, etc. . . . ). The doctor will cut holes into the traditional denture where temporary copings that are attached to the implants can be luted to the denture. These holes will typically extend through both the pink base plate acrylic and the denture tooth. Additional acrylic material may be used to fill any gaps or voids between the traditional denture and the patient's soft tissue. Once the modifications to the traditional denture have been completed (cutting holes, attaching temporary copings, and adding acrylic), the traditional denture will be referred to as the temporary restoration.

During the 6-month healing period, the patient places occlusal loads and forces onto the temporary restoration. Due to the design and modifications performed by the doctor in retrofitting the traditional denture to the implants, the patient can experience a breakage scenario of the temporary restoration. Typically, the breakage occurs in the area of the access hole the doctor cut though the pink base plate acrylic and denture tooth. The bond between the denture tooth and the pink acrylic base plate material relies upon the bottom acrylic portion of the denture tooth bonding to the pink base plate acrylic. When this hole is cut through the denture tooth and the pink base plate material, the amount of surface area where this bonding occurs is reduced dramatically. As the patient applies occlusal loads in these areas, the bond between the denture tooth and the pink base plate acrylic will break and the denture tooth will dislodge from the temporary restoration. Also, in some extreme instances the structural integrity of the temporary restoration or denture tooth can be impacted and a breakage of the temporary restoration or the denture tooth can occur.

The resulting breakage and repair scenarios are inconvenient for both the patient and the doctor. Each time the temporary restoration breaks the patient has to return to the doctor's office where the temporary restoration can be repaired properly. The doctor is also compelled to see the patient the same day as the breakage and will typically see the patient regardless of the number of patients already on the schedule. The doctor will typically not charge for any of the costs associated with this breakage and in addition to the use of materials will typically result in 1-2 hours of chair time depending upon the severity of the break. Over time these breakages can result in a loss of profitability in performing these types of repair procedures.

A need exists for an improved product and method to advance the current state of the art for the temporary restoration. The product needs to address the breakage issues associated with the current technique and provide a time saving method in delivering a provisional restoration at the time of surgery. In addition to the improved performance, if additional features can be incorporated into the provisional restoration to aid with the surgical process (such as bone reduction and potential abutment selection), these features could improve the overall quality of the implant placement and outcome for the final restoration.

In addition to providing a provisional restoration at the time of surgery, there is a need for improving the current impression and diagnostic wax up process which results in an impression prosthesis. Typically after osseosintegration has been completed, the restorative doctor will impress the implants/abutments in the patient's mouth and begin fabricating a mockup of the final restoration, commonly called a diagnostic wax up. The impression process is fraught with issues of accuracy and typically a verification jig is required that confirms the accuracy of the analog positions in the stone cast. Creating the mockup of the final restoration or diagnostic wax up is also a time consuming process. Typically, a wax bite rim is created to identify the vertical and centric relationship of the opposing arches. The dentist will mark or identify the midline, canine position, and smile line on the wax bite rim. On the basis of these markings, the technician will select denture teeth of the appropriate height and width for use in the diagnostic wax up. The diagnostic wax up will be sent for a try in with the patient. On the basis of patient's feedback and review of the tooth position and occlusal scheme, the diagnostic wax up will be sent for adjustments or for different denture teeth to be utilized in the diagnostic wax up. Depending upon the type and number of adjustments, it may take multiple visits with the doctor and patient to ensure the appropriate function and esthetics are obtained for the final prosthesis.

A similar process of duplicating the temporary restoration was found in application Ser. No. 14/174,985, where the inventor duplicated the traditional denture that was used as the temporary restoration in a clear or white acrylic. This process involved delivering the temporary restoration and then returning it to the stone cast in the laboratory, where an impression of the temporary restoration on the stone cast would be made. The impression would then be used to create a duplicate using a white acrylic. Some of the problems or limitations associated with this process is the increased time during the surgical visit for both the doctor and the patient. The anesthesia given to the patient may wear off and the patient may become uncomfortable while waiting for the duplication process to occur. Also, due to the patient being under anesthesia, the patient may not be able to provide critical feedback during the delivery of the provisional restoration regarding comfort or occlusion. During the follow up visits the doctor may need to make adjustments to the provisional restoration, which obviously would not be captured in the duplicate made at the time of surgery. Also utilizing a clear or white acrylic, the patient is not able to provide feedback with regards to the esthetics of the planned completed provisional restoration. Having the patient agree to the desired shade and the contours of the teeth and gingiva are a critical aspect in determining the design for the final restoration. Also, performing the impression at the time of surgery is not ideal as the soft tissue and bone around the implants are healing and soft issue will resorb during the healing process. Any impression taken at the day of surgery will provide an inaccurate representation of the soft tissue contours the final dental prosthesis will need to interface. There are obvious limitations and need for improvements over this process or the traditional methodology discussed earlier in the application.

In application Ser. No. 12/236,325, the inventor discloses the use of a clear surgical guide for impressing and capturing the vertical dimension for the case. Again, we are faced with the similar problems as outlined above. Utilizing a clear acrylic will not provide a proper representation of shade of the teeth or gingiva for the final restoration. Also taking the impression at the time of surgery, the dentist will not capture an accurate impression of the soft tissue contours. The surgical guide will also include flanges to help in orienting the surgical guide on the edentulous ridge, meaning the dentist and the patient will not have an accurate representation of the gingiva contours of the final dental prosthesis. Additionally, the surgical guide may be too bulky or provide a level of lip support that may not be duplicated in the final dental prosthesis. This process has obvious limitations as well.

A need exists for an improved product and method to advance the current state of the art for the impression and diagnostic wax up process. The product needs to reduce the number of visits between the doctor and patient and provide improved accuracies over the traditional process.

### SUMMARY OF THE INVENTION

In accordance with the first embodiment of the invention, a provisional dental restoration is disclosed where the design of the provisional dental restoration includes the teeth and base plate portion designed into a single structure. The provisional dental restoration consists of a series of recesses to receive copings that allow for attachment to the implants and abutments in the patient's mouth. The design of the provisional dental restoration is determined from digital data defining the appropriate tooth and gingiva contours for the provisional dental restoration. The position of the series of recesses is determined from digital data defining the patient's current or planned clinical condition. The series of recesses is also designed with the use of a unique subtract body. Finally the provisional dental restoration is manufactured from an appropriate dental material to provide the required shade and esthetics for the patient.

In accordance with the second embodiment of the invention, an impression prosthesis is disclosed where the design of the impression prosthesis includes the contours of the teeth for a provisional dental restoration or final dental prosthesis. The impression prosthesis consists of a series of recesses to receive copings that allow for attachment to the implants and abutments in the patient's mouth. The design of the impression prosthesis is determined from digital data defining the appropriate tooth and gingiva contours for the provisional dental restoration or final dental prosthesis. The position of the series of recesses is determined from digital data defining the patient's current or planned clinical condition. The series of recesses is also designed with the use of a unique subtract body. Finally the impression prosthesis is manufactured from an appropriate dental material to provide the required shade and esthetics for the patient.

### BRIEF DESCRIPTION OF THE SEVERAL VIEWS OF THE DRAWING

FIG. 1 is a cross sectional view of an anchor properly placed in a patient's jawbone.

FIG. 2 is an occlusal view of the prefabricated denture seating on top of the stone cast.

FIG. 3 is a cross-sectional view of the prefabricated denture of FIG. 2 properly seating of the stone cast.

FIG. 4 is a perspective view of an anchor with an impression coping properly attached.

FIG. 5 is a fragmentary perspective view of a patient's open mouth with the anchors embedded in the patient's mandible.

FIG. 6 is a fragmentary perspective view of the patient's open mouth with several copings attached to the anchors and an impression tray with impression material surrounding the patient's mucosal tissue and submerging the copings.

FIG. 7 is a perspective view of the impression of FIG. 6 inverted and removed from the patient's mouth with two analogs attached to two of the copings.

FIG. 8 is the same perspective view of FIG. 3, but with analogs attached to all the copings, and the impression filled with dental stone material and the analogs submerged in the dental stone material.

FIG. 9A is a perspective view of the stone cast with copings attached to the analogs in creating the verification jig.

FIG. 9B is the same perspective view of FIG. 9A, with acrylic added to attach the copings to one another in fabricating the verification jig.

FIG. 10 is a perspective view of a maxillary stone cast with analogs.

FIG. 11 is the same perspective view of FIG. 10 with temporary copings attached to the analogs in the maxillary stone cast of FIG. 10.

FIG. 12 is a perspective view of prefabricated denture with holes cut to seat over the temporary copings and analogs in the maxillary stone cast.

FIG. 13 is a cross-sectional view of the prefabricated denture in FIG. 12 showing the fit of the denture over the temporary coping and analog in the maxillary stone cast.

FIG. 14 is a schematic diagram of the scanner and the wax-up framework and alignment posts that it is scanning.

FIG. 15A is a perspective view of the invented provisional with the denture teeth and acrylic base plate portion designed into a single piece.

FIG. 15B is another perspective view of the invented provisional showing the stone cast mating surface, trough and digital cutback.

FIG. 16 is a perspective view of the invented provisional seating on the maxillary stone cast.

FIG. 17 is a cross-sectional view of the invented provisional of FIG. 16 demonstrating the position of the trough relative to the analog in the maxillary stone cast.

FIG. 18 is a perspective view of the invented provisional seating on the maxillary stone cast with holes cut and temporary copings attached to the provisional.

FIG. 19 is a flow chart demonstrating the steps necessary for delivering the invented provisional with a designed trough at the day of surgery in a chair side procedure.

FIG. 20 is a flow chart demonstrating the steps necessary for preparing/delivering the invented provisional with a designed trough at the day of surgery using a traditional impression and stone cast process at the laboratory bench.

FIG. 21 is a flow chart demonstrating the steps necessary for preparing/delivering the invented provisional with a designed trough at the day of surgery using the provisional as an impression for creating the stone cast used in completing the provisional restoration at the laboratory bench.

FIG. 22 is a cross-sectional view of the invented provisional of FIG. 18 demonstrating the fit of the provisional on the stone cast with the temporary coping properly attached.

FIG. 23 is a perspective view of the invented provisional designed with four recesses for receiving the temporary copings.

FIG. 24 is a cross-sectional view of the provisional seating on the stone cast with the temporary coping properly attached to one of the designed recesses shown in FIG. 23.

FIG. 25 is a cross-sectional view of a provisional seating on a stone cast and demonstrating the use of the buccal flange for identifying the required bone reduction required for a case.

FIG. 26 is the same cross-sectional view of FIG. 25 demonstrating the bone reduction performed and being confirmed with the position of the buccal flange.

FIG. 27 is a flow chart demonstrating the steps necessary for using the invented impression prosthesis (a duplicate of the provisional restoration) for creating the final impression and stone cast used for fabricating the final restoration.

### DETAILED DESCRIPTION OF THE INVENTION

The present disclosure reveals the process of creating a provisional dental restoration.

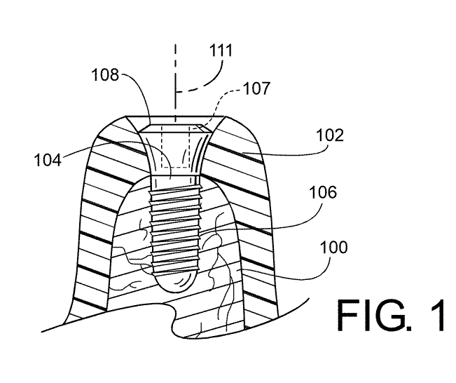

A dental prosthesis is supported by a series of dental implants or anchors placed in the patient's jaw bone. The number of dental implants or anchors can vary greatly in number, orientation, and position dependent upon the available bone and requirements for the dental prosthesis. While the final dental prosthesis is being fabricated, the dentist will typically deliver a provisional restoration that will stabilize the implants and provide chewing function for the patient during the healing phase. In FIG. 1, the patient's jaw or mandible 100 can be seen overlaid with soft mucosal tissue 102 (known commonly as “gum tissue”). An anchor 104, also known as an “implant” or “fixture” is shown embedded into the patient's mandible 100. This anchor is retained within the bone of the mandible by a screw thread. The screw thread is driven into the mandible 100 by coupling a wrench or similar device to the top of the anchor 104 and rotating the wrench to drive the anchor into the jaw bone just as one would drive a screw into a piece of wood. In an alternative embodiment, the anchor 104 is press fitted into a hole formed with a drill, reamer, broach, osteotome, or similar device.

FIG. 1 illustrates the first step in the process of the making and fitting of a provisional restoration and the associated final dental prosthesis, that of forming an opening in the mandible of the patient and fixing an anchor therein, while leaving a top surface of the anchor exposed above mucosal tissue 102 for mating (coupling) to and supporting a dental prosthesis or restorative component such as a denture, bridge, crown, framework, temporary restoration, provisional restoration, final prosthesis hybrid, overdenture, abutment, healing cap, or coping. Note that while the process illustrated describes a mandible for illustration purposes, the same process is performed to embed anchors 104 into the patient's maxilla and create dental prostheses for the maxilla.

To attach anchors 104, the dentist first makes an incision in the mucosal tissue 102 where a missing tooth or teeth would normally extend from the mandible where it is embedded, through the gum, and into the oral cavity. Once the incision is made, the dentist makes a hole (which may include such processes as drilling, broaching or reaming) in the mandible 100 in the same general direction and location as the missing tooth. The dentist then fixes an anchor 104 into the hole thus created and sutures the incision, typically leaving mating surface 108 of anchor 104 exposed so that a provisional restoration may be placed and temporarily restore the patient's chewing function during the healing process. The provisional restoration can consist of a crown, bridge or full mouth denture.

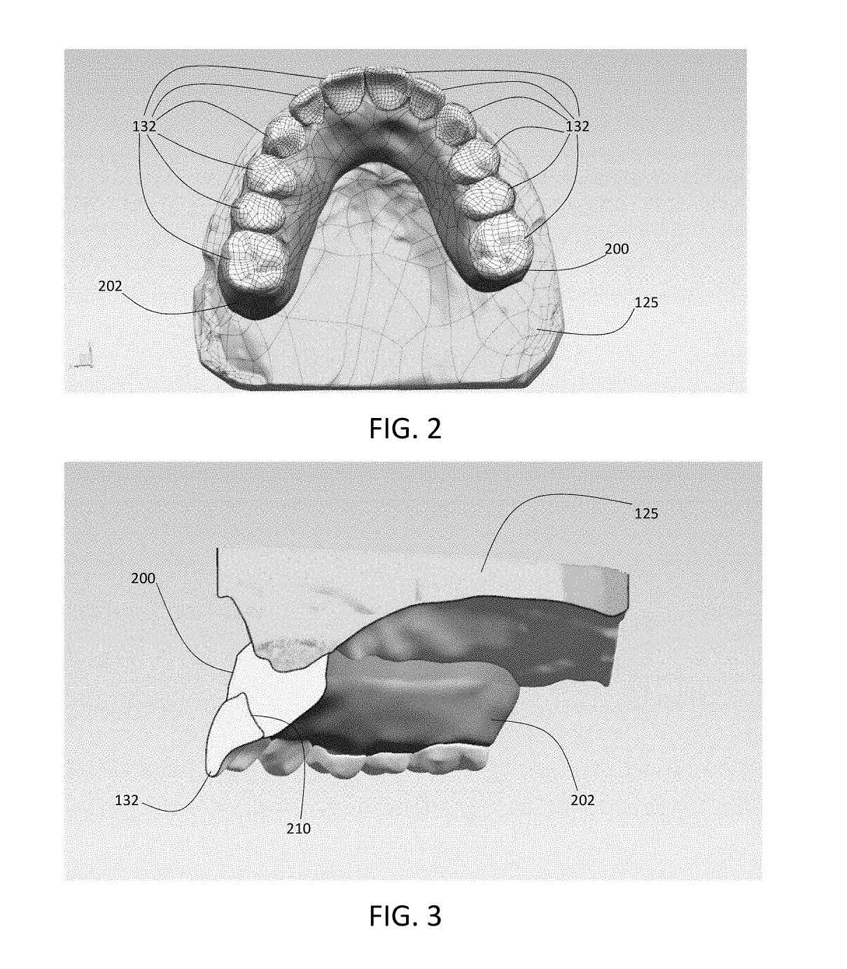

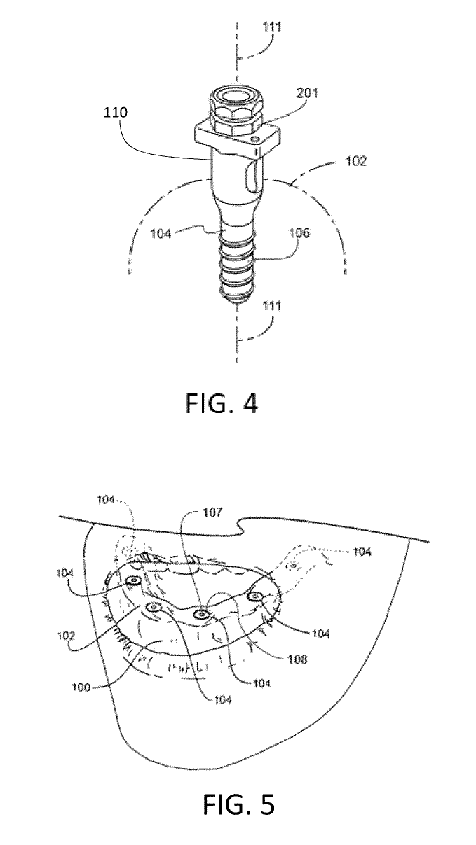

Upon completion of the surgical placement of all anchors 104 into the patient's jaw bone, the dentist will begin the process of delivering the provisional restoration. Traditionally, the temporary restoration consists of a prefabricated denture 200 as shown in FIGS. 2 and 3 that has been fabricated prior to surgery. If the patient already has an existing denture, the dentist may choose to modify the existing denture as the prefabricated denture 200 in creating the temporary restoration. The prefabricated denture 200 in FIGS. 2 and 3 show a denture for a maxillary arch. It can be appreciated that a similar denture can be used for a mandibular arch. This prefabricated denture is typically fabricated from study casts and a diagnostic wax up the dentist creates prior to surgery. The study casts will reflect the patient's current dental condition. If the study casts include any existing dentition, the technician will reduce these contours of the stone cast to reflect any existing dentition that will be removed at the time of surgery. The diagnostic wax up 130 (also commonly referred to as a denture tooth set up) is fabricated utilizing wax 134 and denture teeth 132. The denture teeth 132 are positioned in the appropriate position and in order to create the appropriate occlusion with the opposing arch. Wax 134 will possess all of the gingiva contours and mating surfaces to mate with stone cast 125 and ultimately the patient's mouth. Once the denture teeth 132 have been verified to being placed in the appropriate position, the dentist or dental technician will process the prefabricated denture 200 using a lost wax technique. The lost wax technique involves placing the diagnostic wax up 130 in a stone mold or cast and the wax 134 of diagnostic wax up 130 will be removed through a boil out technique. This process is commonly used in the dental industry. Once wax 134 has been removed from the cast, the dentist or technicians will steam the stone mold and denture teeth 132 to remove any residual wax. The denture teeth will be placed back into the stone mold and an acrylic 201 will be injected, poured, or packed to complete the denture. The prefabricated denture 200 consists of an acrylic base plate portion 202 and a series of denture teeth 132. The acrylic base plate portion 202 reflects all of the contours of wax 134 in diagnostic wax up 130 and will appropriately mate with stone cast 125. The acrylic base plate portion 202 for prefabricated denture 200 in FIGS. 2 and 3 does not fully cover the palatal portion of the maxilla. The base plate portion 202 can extend over the palate and aid in seating the provisional restoration in the patient's mouth. For mandibular arches the base plate portion can also extend to the retro molar pads and into the depth of the vestibule in a similar fashion to aid in delivering the provisional restoration to the patient's mouth. Typically, these portions will be trimmed away by the dentist prior to delivering the final provisional restoration and their inclusion into the design of the prefabricated denture 200 is purely clinical preference. The dentist will modify this prefabricated denture 200 to allow for temporary copings or fittings 206 to be attached to the prefabricated denture 200 and allow the prefabricated denture 200 to be attached to the implants that have been surgically placed in the patient's jawbone. Typically, a screw will pass though the temporary coping to fixate it to the dental implant. However, additional retention means such as a mechanical retention (Zest F-Tx Abutment or Rodo Medical, Smileloc) or cement retention can be used. The dentist can choose to modify the prefabricated denture 200 chair side or in the laboratory. For either process, the dentist will review the positions of the anchors 104 and cut through holes on the basis of where he perceives the implants to correlate with the position of the prefabricated denture 200. If he is performing the process chair side, he will attach the temporary copings 206 to the anchors 104 and utilize a self-curing or light curing resin or acrylic to attach the temporary copings 206 to the prefabricated denture 200 thereby attaching the prefabricated denture 200 to the anchors. The combination of the temporary cylinders and prefabricated denture 200 now becomes the embodiment of the temporary restoration 208. Typically, the holes that are cut into the prefabricated denture 200 to receive the temporary copings 206 are oversized due to the inaccurate method of accounting for their position and to accommodate the multiple heights and angulations of the multiple temporary copings when fitting the prefabricated denture 200 over them. Once the temporary copings 206 have been attached to the prefabricated denture 200, the dentist will remove the temporary restoration 208 and fill any gaps, refine any contours and polish the provisional restoration before seating it back on to the anchors 104 in the patient's mouth.

Some dentists may choose to take an impression of the anchors by utilizing impression copings and creating a stone cast, where the dentist can more easily and accurately modify the prefabricated denture 200 in comparison to performing the process chair side in the patient's mouth.

The anchor 104 has a central longitudinal aperture 107 in the top, which is configured to receive an impression coping 110, as shown in FIG. 5, (or a fastener configured to mount the impression coping 110) that is affixed to the anchor 104. This coping transfers the size, shape, location or orientation of the mating surface 108 of the anchor (and preferably all four) to the stone cast (see below). It is the mating surface 108 that is oriented to the provisional restoration and the final prosthesis, and the structures of the provisional restoration and final prosthesis that mount to the anchors are derived from this surface 108. In general, anywhere from one to twelve of these anchors are embedded in the jaw and are provided as mounting points for the provisional restoration or final prosthesis. In an alternative configuration, anchor 104 may have a variety of configurations on its mating surface 108 including threaded or unthreaded protrusions or recesses that are configured to engage a provisional restoration or final prosthesis. The use of an anchor 104 having a central aperture and internal threads for engaging a coping is a matter of convenience herein and should not suggest that the process is limited to an anchor having this configuration.

Mating surface 108 is typically the surface on which the provisional restoration or final prosthesis will be mounted or an abutment surface having a predetermined position with respect to that surface 108 on which the provisional restoration or final prosthesis will ultimately be mounted. The coping 110 is configured to engage surface 108 and surrounding structures of anchor 104 (if any) such as holes that extend into (or protrusions that extend above) the surface 108.

These inter engaging surfaces of coping 110 and anchor 104 serve to align the coping and the anchor in predetermined positions with respect to each other when fixed together, such that, if one knows the position and orientation of surfaces on the coping, one can know the position and orientation of corresponding structures on the anchor 104 and more preferably when a scanner (see below) determines the position and orientation of structures on copings 110 the scanner can mathematically determine the position and orientation of corresponding structures on anchors 104. Anchor 104 is preferably cylindrical and has a longitudinal axis 111, as does coping 110. In a typical arrangement, when the coping 110 is fixed in its predetermined position with respect to anchor 104, a longitudinal axis 111 of the coping is coaxial with the longitudinal axis of the anchor 104. The coping 110 and the anchor 104 are preferably threadedly engaged to permit surfaces on the coping to be drawn down tightly against mating surface 108 for precise alignment of the inter engaging surfaces. Alternatively, the coping 110 and anchor 104, to which it is coupled, may be equipped with inter engaging snap fastening connecting surfaces that hold the coping in the proper orientation with respect to the anchor 104.

In FIG. 5, the edentulous mandible 100 has six anchors 104 affixed therein in a spaced-apart relation extending from the front of mandible 100 around each side. The anchors 104 are placed in a generally upright and parallel relation extending into the top surface of mandible 100. The dentist attaches corresponding copings 110 to the top of each anchor 104 that extend upward in a generally upright and parallel relation to the other copings 110. The copings can include a threaded portion or a snap fastening portion that allows them to be retained to anchor 104. The application illustrated herein shows the use of six anchors configured to support a denture. Other applications with more or fewer anchors 104 are possible. Furthermore, the mandible need not be edentulous (shown here), but may have, and often does have, one or more natural teeth remaining in the maxilla or mandible between which the anchors 104 are embedded to support one or more dentures (such as fixed or removable partial dentures) to fill the gap or gaps between the existing natural teeth. In this case, the anchors would not be spaced evenly about the mandible, as shown here, but would be spaced irregularly in the gaps created by the absence of natural teeth.

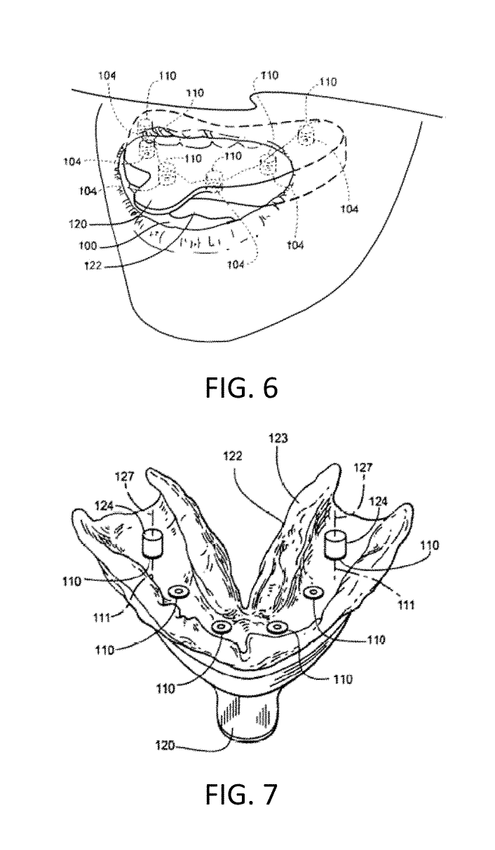

FIG. 6 illustrates the next step in the process of creating the provisional restoration or final prosthesis, creating an impression of the patient's jawbone and anchors. This figure shows an impression tray 120 filled with flexible impression material 122. The tray is a semi-flexible plastic structure that holds the impression material 122 in position around the patient's teeth (if any) and mucosal tissue. FIG. 6 shows a tray 120 for the lower teeth, surrounding teeth, mucosal tissue, and mandible of the patient.

The copings 110 previously attached by the dentist to the anchors 104 are completely submerged by the dentist in impression material 122 such that the entire outer surfaces of the copings 110 extending above the surface of the mucosal tissue on the patient's mandible 100 are completely covered. The impression material 122 is left in this position to set. Once set, the individual copings 110 are fixed with respect to each other in the same position and orientation that the anchors 104 are fixed with respect to each other. The curing process fixes the copings in this position and thereby permits the copings to be collectively removed together with the impression material while preserving their orientation.

In the next step of the process, the dentist flexes the tray 120 and the now set impression material 122 and removes them from the patient's mouth. Enough impression material 122 is placed in the tray 120 and disposed around the patient's mandible 100 to cover any still-existing teeth of the mandible and the mucosal tissue 102 of the mandible as well as the copings 110.

When the tray 120 and impression material 122 are removed, the copings are removed with them, embedded in the now-cured impression material 122. The process of removal disconnects the copings 110 from the anchors 104, permitting the copings to be removed while still embedded in the impression material 122. If the copings include a threaded portion that holds them to the anchors, this threaded portion is unthreaded from the anchors. If the copings are fastened to the anchors with a snap fastening portion, the snap fastening portions are unsnapped from each other. The now-cured impression material 122 that couples the copings 110 to each other preserves the relative positions and orientations of the mating surfaces of all the copings 110 and hence relative positions and orientations of the mating surfaces 108 of all the anchors 104 with respect to each other. This relationship is preserved in the relative positions and orientations of the surfaces of copings 110 that were connected to the mating surfaces 108 of anchors 104. To even further ensure the preservation of this relationship, some dentists will attach the copings 110 to one another by applying a light cured or self-curing acrylic or resin material prior to submerging them in the impression material 122. The impression material 122 in which copings 110 are embedded also preserves the surface contours of the mucosal tissue and the remaining teeth (if any) in the mandible and their relative positions with respect to the mating surfaces of copings 110 and anchors 104. The surface of the impression material 122, once removed from the patient's mouth, is a negative replica of the soft tissue and teeth. The surfaces of copings 110, now separated from anchors 104 and exposed on the inside surface of the impression material 122, are a negative replica of surfaces 108 of anchors 104 to which they were coupled. The now-cured impression material 122 is therefore a negative replica of all the free surfaces, including teeth, mucosal tissue, and the surfaces of the copings embedded in the impression material are a negative replica of the mating surfaces 108 of anchors 104. The cured impression material with embedded copings is commonly called an “impression” and identified in the figures herein as item 123. After completing the impression for the arch is being restored, the dentist will typically impress the opposing arch to capture the surfaces of the teeth, mucosal tissue or any dental prosthesis. The dentist will also take a series of inter occlusal records utilizing a face bow, bite, wax bite rim or combination of the previously mentioned. This process allows the dentist and technicians to accommodate these surface contours into the design of the provisional restoration or final prosthesis as it will need to properly occlude these surfaces.

FIG. 7 shows the impression 123 inverted and removed from the patient's mouth. In this embodiment, there are six copings 110 embedded in the impression 123. The bulk of the copings 110 are embedded in the impression 123. Only the very ends of the copings 110 extend upward and out of the impression 123 (in this inverted orientation).

In FIG. 7 the dentist has begun the next step of the process, that of attaching analogs 124 to the exposed surfaces of all of the copings 110. Analogs 124 are structures that replicate the anchors 104. As in the case of the copings 110 themselves, each analog 124 preferably comprises a generally cylindrical body with a longitudinal axis 127 that is coaxial with the longitudinal axis 111 when attached to coping 110.

The end surfaces of analogs 124 are configured to abut and mate with the free surfaces of the copings 110 that were previously coupled to anchors 104 and normally attach in the same manner as copings 110 to anchors 104. The surfaces of analogs 124 replicate the position and orientation of mating surfaces 108 of anchors 104. In effect, the spacing and orientation of anchors 104 was transferred to the copings 110, and transferred back again to analogs 124, which have the same spacing and orientation as the anchors 104. Thus, each analog 124 is coaxial with and is disposed in the same position as anchor 104.

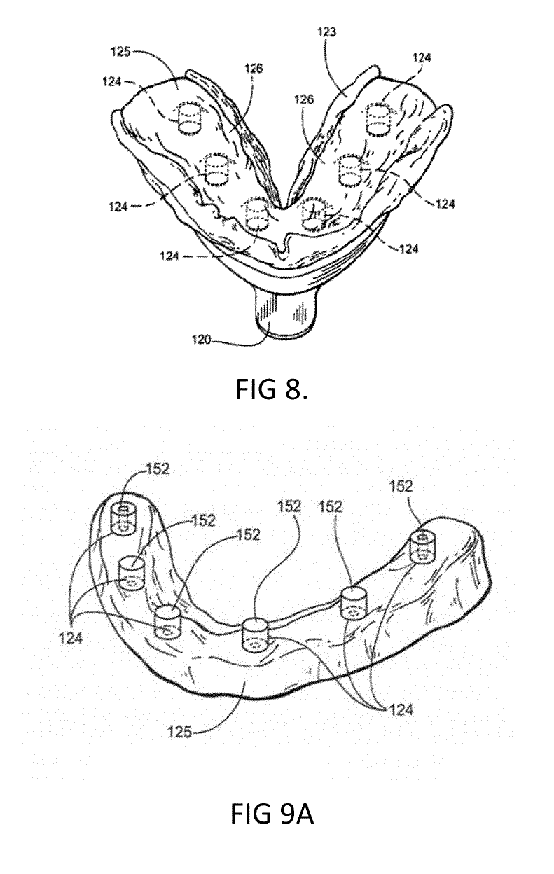

In the next step of the process, illustrated in FIG. 8, the dentist pours a mixed dental stone material 126 into the cavity in impression 123 that was formed by the patient's mandible, submerging all of the analogs 124. Stone material 126 covers the exposed portion of the analogs 124 as well as the surfaces of impression 123 formed by the patient's mucosal tissues and teeth. Once filled into impression 123, the stone material 126 is then permitted to harden to a rock-like consistency, creating a structure that is called a “stone cast” 125. The dentist or technician may also choose to use a soft tissue material for some areas of stone cast 125. This soft tissue material is typically a silicone or other approved polymer material and is applied in the areas around the analogs 124 prior to the stone cast material 126 being poured into impression 123. It is also at this time that the dentist or technician will pour up the impression of the opposing arch to provide a positive replica of the surfaces of the patient's opposing dentition, mucosal tissue or dental prosthesis.

FIG. 8 represents the next step of the process which the dentist performs once the stone material 126 has hardened. The dentist removes impression 123 from the stone cast 125, leaving the stone cast 125 with the analogs 124 embedded therein. The stone cast 125 positively replicates the position and orientation of mating surfaces 108 of anchors 104, which are represented in the stone cast 125 by the mating surfaces 128 of the analogs 124 that were fixed to the free ends of copings 110 (FIG. 3). The portions of the stone cast 125 surrounding analogs 124 positively replicates the surface of the mucosal tissues of the mouth, which were transferred from the mucosal tissues of the mouth to the impression as a negative replica and then back to the stone cast as a positive replica of those tissues. The stone cast 125 also replicates the surface of the patient's existing teeth (not shown). When the patient has existing teeth, the position and orientation of the surfaces of the teeth are transferred first to the impression as a negative replica and then to the stone cast as a positive replica. In the present embodiment, the mandible 100 is edentulous and therefore there are no existing teeth.

The impression molding and stone casting processes described above provide accurate replicas of the position and orientation of the mating surfaces 108 of anchors 104, the mucosal tissues, and the teeth.

In the preferred embodiment, the mating surfaces 108 of anchors 104 are exactly duplicated by the mating surfaces 128 of the analogs 124: they are in exactly the same position and at exactly the same orientation. In an alternative embodiment, the mating surfaces 128 on the analogs may be offset slightly or configured slightly differently than the mating surfaces 108 of anchors 104. In some cases, manufacturers choose to make analogs or other connecting components that have mating surfaces slightly different from the mating surfaces 108 of the anchors 104; for example, to permit the copings 110 to be more easily attached to anchors 104 or to permit analogs 124 to be more easily attached to copings 110. Any slight differences in position such as this is intentional, however, and is eliminated later in the process when the denture is created so that the mating surfaces of the denture are precisely oriented to mate properly with surfaces 108 of anchors 104 in the patient's mouth.

Further, the anchors 104 in the patient's mouth may not be connected directly to the provisional restoration or final prosthesis. Abutments may be mounted on the anchors 104 (i.e. the anchors have surmounted abutments). The may be mounted to these abutments, and thus indirectly mounted to anchors 104. When the provisional restoration or final prosthesis being designed is intended to be mounted on abutments mounted on anchors 104, the analogs 124 may be provided with surmounted abutments, i.e. the analogs may include the abutment design incorporated into it, to replicate the mating structure of the abutment to the framework.

While the mating surfaces 128 of the analogs 124 and the mating surfaces 108 of anchors 104 may be slightly different, the longitudinal axis of each of the anchors 104 and the analogs 124 are preferably identically oriented and spaced apart, each pair of corresponding analog and anchor sharing a common longitudinal axis (i.e. they are coaxial). Considered differently, if the surface of the stone cast representing the soft tissues and teeth of the patient's mouth could be superimposed on top of the patient's mucosal tissues 108 that formed the stone cast 125, all the longitudinal axis defined by the analogs would be superimposed on (i.e. simultaneously coaxial with) all the corresponding axis defined by the anchors. The longitudinal axis 127 of the analogs 124 and the surfaces of the stone cast 125 defined by the mucosal tissues 108 the patient are positive replicas of the longitudinal axis 111 of anchors 104 and the surfaces of mucosal tissues 108.

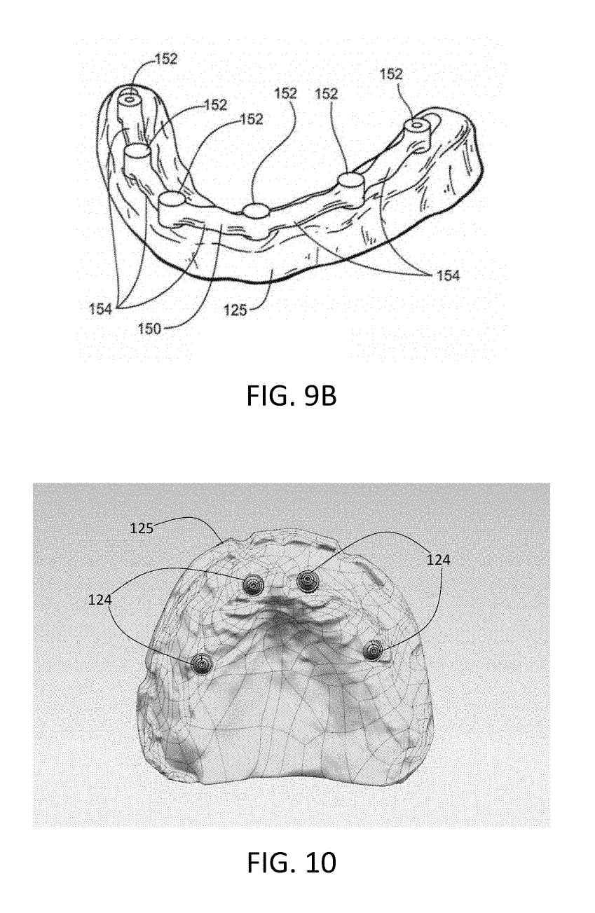

In order to confirm the position and orientation of analogs 124 in stone cast 125 correlates with the position and orientation of anchors 104, the dentist or dental technician will create a verification jig on the stone cast 125 as depicted in FIGS. 9A and 9B. The verification jig is created using a series of copings 152 attached to the analogs 124 in stone cast 125 and linking these copings together with some self-curing or light curing acrylic or resin 154. Once the acrylic or resin 154 has hardened, the copings are in a fixed orientation to one another. The verification jig can now be removed from the stone cast and placed on the anchors in the patient's mouth where the fit will be assessed. If the fit is accurate, the analog positions in the stone cast are considered verified. If the fit is inaccurate, the dentist or technician will section the verification jig in the area of the misfit and lute the verification back together in the patient's mouth using a self-curing resin or acrylic. The dentist or technician can choose to reposition the misaligned analog in the current stone cast or take a new impression with the verification jig attached to the anchors 104 in the patient's mouth. The dentist may choose to skip this step in creating the stone cast at the time of surgery depending upon the time frame in which they are trying to deliver the provisional restoration.

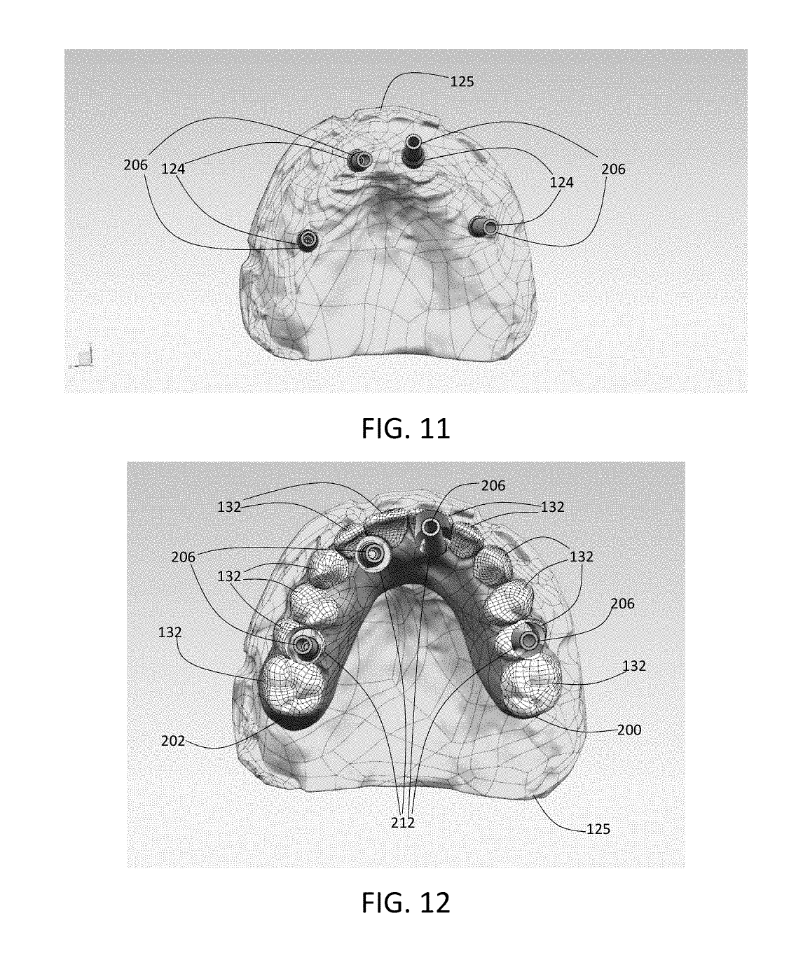

The replica of any teeth formed in the surface of the stone cast are formed with respect to one another and with respect to the analogs such that they duplicate the position of any existing real teeth in the patient's mouth with respect to one another and with respect to mating surfaces 108 and longitudinal axis of the anchors 104 in the patient's mandible. The replica of the mucosal tissues formed in the surface of the stone cast are in generally the same position on the stone cast as they are in the patient's mouth including the replication in the stone cast 125 of the junction between the mucosal tissue and any existing teeth and anchors 104, as well as a replication in the stone cast of all the mucosal tissue that will be covered by the denture. The dentist will mount stone cast 125 into an articulator along with an opposing cast by creating inter occlusal records through means of a face bow, bite or the use of a wax bite rim. Mounting the stone cast 125 along with the opposing cast allows the dentist to review and confirm occlusion of the provisional restoration before delivering it to the patient's mouth. FIG. 10 shows a stone cast 125 with four analogs 124 for a maxilla and demonstrates a fully edentulous arch and the appropriate mucosal tissue contours that have been duplicated from the impression taken of the patient's anchors and mucosal tissue.

The dentist will next cut the necessary holes 212 in the prefabricated denture 200 to receive the temporary copings 206. In order to do so the dentist will position the prefabricated denture 200 over the position of the analogs 124 in stone cast 125 and by eye determine where the holes 212 need to be cut in correlation with the prefabricated denture 200. The holes 212 are typically oversized to ensure the prefabricated denture 200 can be positioned over all temporary copings 206. The dentist will attach temporary copings 206 to analogs 124 as shown in FIG. 11 and attach the temporary copings 206 to the prefabricated denture 200 by means of a self-curing or light curing resin or acrylic. Once the temporary copings 206 have been attached to the prefabricated denture 200, the prefabricated denture 200 has become the temporary restoration 208. The dentist will also fill any voids, refine any contours and polish the provisional prior to seating the provisional restoration back onto the anchors 104 in the patient's mouth. Having a fabricated stone cast 125 also aids in any repair scenarios associated with the temporary restoration 208 for the patient.

It can be appreciated that the aforementioned processes of modifying the prefabricated denture 200 in fabricating the temporary restoration 208 could be performed with a patient's existing denture if available.

One of the major issues that the dentist encounters in creating temporary restoration 208 with a prefabricated denture 200 is frequent breakage of the denture teeth 132 from the temporary restoration 208. This issue is a result of the inaccurate cutting of holes into the prefabricated denture and the reduction of the bonding surface between the denture tooth and the base plate acrylic.

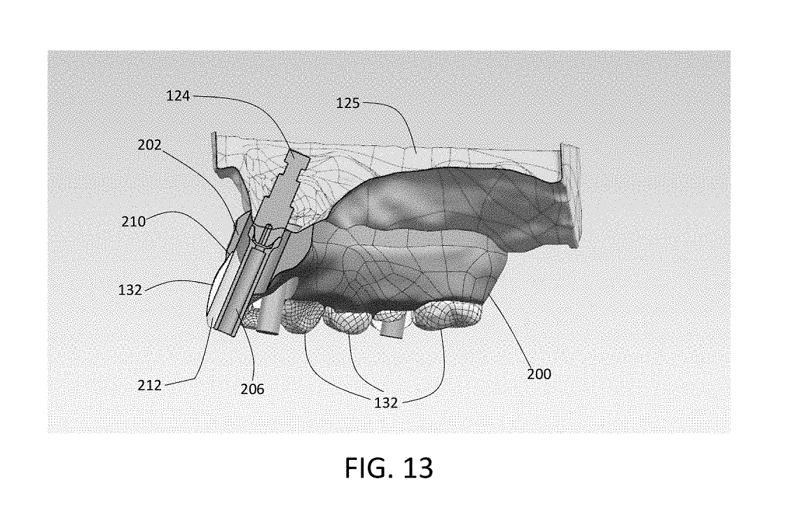

FIGS. 2 and 3 depicts a prefabricated denture 200 with denture teeth 132 and an acrylic base plate portion 202 seating on stone cast 125. FIG. 3 provides a cross-sectional view of prefabricated denture 200 seating on stone cast 125 and demonstrating the bonding surface 210 between the acrylic base plate portion 202 and denture teeth 132. Depending upon the position and orientation of the implants, the bonding surface may remain intact, but in most cases the bonding surface is reduced significantly. FIG. 12 shows the holes 212 the dentist cuts in prefabricated denture 200 in order for the temporary copings 206 to be attached in creating temporary restoration 208. The holes 212 are larger than the diameter of the temporary coping 206 to enable the prefabricated denture 200 to fit over all of the temporary copings 206 at one time. The holes 212 being too large can also be a product of the doctor cutting the holes 212 by eye and purely based upon where he or she perceives where the holes 212 should be positioned in order for prefabricated denture 200 to receive temporary copings 206. The dentist may also cut the hole in the wrong position or cut into an area where the esthetics of the provisional restoration may be compromised, such as an incisal edge or buccal aspect of an anterior tooth. As demonstrated in FIG. 12 and FIG. 13, the denture teeth 132 have been modified and the bonding surface 210 has been reduced between the denture teeth 132 and acrylic base plate portion 202. As bonding surface 210 is reduced, the strength in the bond between the denture teeth and acrylic base plate is weakened. For this reason, the amount of force required to break the denture tooth away from the acrylic base plate is much less than before the hole 212 was cut into prefabricated denture 200. This breakage issue can be extremely problematic for the anterior teeth, where the occlusal forces are usually located at the incisal edge which can generate a leveraging affect further reducing the force required to break the denture tooth 132 from the acrylic base plate 202.

These breakages can be inconvenient for the dentist and the patient. The patient is inconvenienced with enduring a broken, non-functional, and poorly esthetic restoration until it can be repaired. The dentist is compelled to see the patient in the timeliest fashion possible and will typically accommodate the unscheduled visit. This repair scenario is also an unforeseen cost that the dentist will have to cover and which will result in a loss of production and profitability for the case and the practice. In some instances, the denture tooth 132 can be reattached to the temporary restoration 208, but in the worst scenarios, a new temporary restoration will need to be fabricated for the patient.

The dentist can also benefit from a new process for the creation of the temporary restoration that aids in the placement of the temporary copings. With the current prefabricated denture method, the dentist is making a judgment call on the basis of where he or she perceives the holes to be cut into the prefabricated denture 200. There are times where they will mistakenly cut the hole in the wrong position and the current hole has to be enlarged or a new hole has to be cut, which further weakens the temporary restoration. The dentist could also benefit from a new process for the creation of the temporary restoration that can aid them in better identifying the position of the implants/abutments and identify where the holes need to be cut in the temporary restoration.

It can be appreciated that a new process for the creation of a temporary restoration that reduces occurrences of such breakages and improves the quality of the outcome of the provisional dental restoration would be beneficial. The term “provisional dental restoration” will be used in describing the disclosed invention.

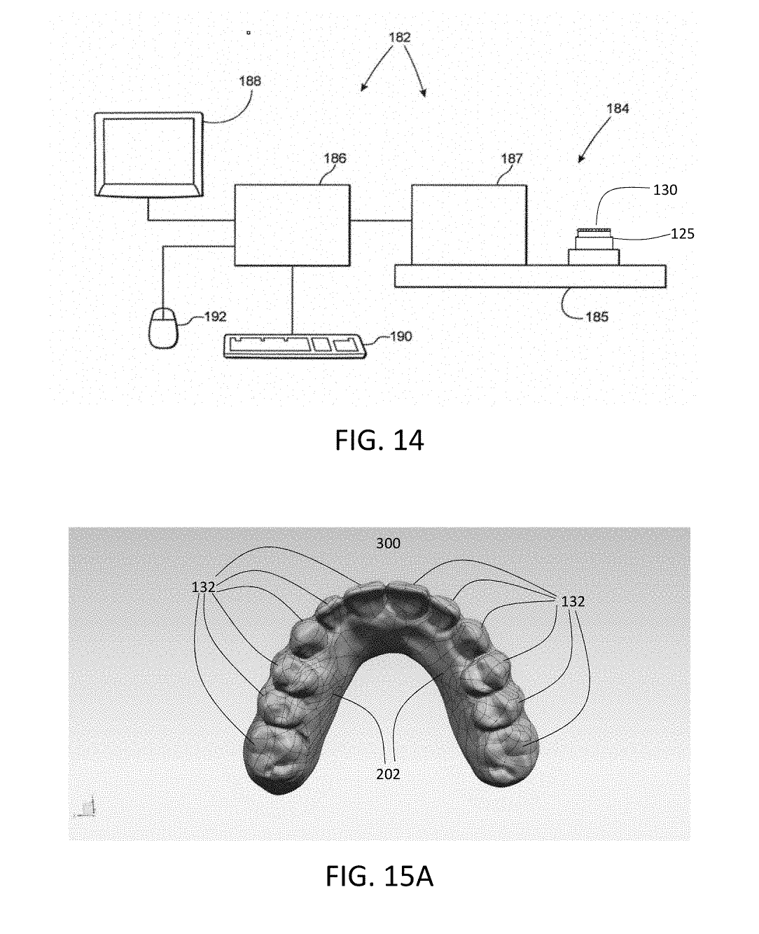

In the first embodiment of the present disclosure, a new process for the creation of a provisional dental restoration is presented. The process allows for denture teeth and acrylic base plate portion to be designed into a single structure and removing the bonding surface to provide a stronger provisional dental restoration over the traditional temporary restoration. In a similar fashion as the temporary restoration 208, the new provisional dental restoration can be created on the basis of the diagnostic wax up 130 contours with denture teeth 132. Diagnostic wax up 130 and stone cast 125 are then scanned utilizing a scanning unit 182 represented in FIG. 14 similar to a scanning system commonly used in the market (3Shape or Nobel Biocare Procera Scanner). Typically these scanning units are table-top units that utilize laser or white light scanning processes. However it can be appreciated that different scanning systems such as intra-oral scanners, CT scanners, or touch probe scanners can be utilized in generating the scan files of diagnostic wax up 130 and stone cast 125. The stone cast 125 will be scanned by itself and diagnostic wax up 130 will be scanned while properly positioned on stone cast 125. This process allows for easy alignment of the two sets of scan data. The scanning unit 182 will be able to align the two scan sets based upon the captured and shared contours of stone cast 125. Alternately, diagnostic wax up 130 can be scanned separately and aligned to the stone cast scan data based upon the contours of the diagnostic wax up that mate with stone cast 125 as discussed in U.S. Pat. No. 8,100,692. Alternatively if the patient has an existing denture, the existing denture can be scanned in place of the diagnostic wax up 130. Once stone cast 125 and diagnostic wax up 130 has been scanned, the scanning unit will generate a stone cast surface model and a diagnostic wax up surface model. Stone cast surface model 225 will be used for generating the appropriate mating surface of the provisional dental restoration 300. Stone cast surface model 225 can be altered to reflect a planned soft tissue or bone reduction to be performed at the time of surgery. This alteration can be based upon measurements taken during the diagnosis and planning phase utilizing CT or Panorex radiographs. The stone cast surface model 225 can also be modified on the basis of surgical guide planning data where digitally planned implants and/or planned bone reduction are incorporated into the stone cast surface model.

Once the stone cast surface model has been finalized, the diagnostic wax up surface model 230 is generated and will provide the basis for the design of provisional dental restoration 300. The scan data of the denture teeth 132 and wax 134 are modeled into a single body. This design aspect ensures the digital representation of the denture teeth portion and acrylic base plate portion are fabricated into a single unit. This design aspect alleviates the common breakage issues associated with prefabricated denture 200 by removing the bonding surface 210 from the design of the provisional dental restoration.

A Boolean operation will be performed to generate the stone cast mating surface 232 into the intaglio surface of diagnostic wax up surface model 230. This process ensures the diagnostic wax up has an ideal surface for seating on the patient's edentulous ridge. Flanges and palatal portions can also be extended or included in the design of the diagnostic wax up surface model 230. These flanges and palatal portions can aid in orienting and positioning the provisional dental restoration 300 over the anchors 104 that have been placed in the patient's jaw bone. For the maxilla, the provisional dental restoration 300 can include a palatal portion for this purpose. For the mandible, flanges can extend back to the retro molar pads or extend into the vestibules similar to a denture. The scanning operator will utilize a unique CAD body 234 to create a trough 236 or series of recesses 238 into the intaglio surface of diagnostic wax up surface model 230. The trough and recesses are intended to receive the temporary copings 206. For the trough, the scan operator will position CAD body 234 along the crest of the ridge of stone cast surface model 225. Once appropriately positioned, a Boolean subtraction will be performed to create the trough in the diagnostic wax up surface model 230. It can be appreciated trough 236 can have any size or shape based upon the doctor's or operator's preference. Trough 236 can have various heights and widths on the basis of the size, shape and contours of the stone cast surface model 225 and diagnostic wax up surface model 230. The trough 236 can extend along the entire arch or can be positioned only in areas where the dentist is planning on placing anchors 104. The trough 236 can also be broken up into sections.

The trough 236 can also be designed to receive a bar, framework or other support structures designed for the case. As noted in application Ser. No. 15/068,423, a framework can be digitally designed on the basis of scan data captured of the diagnostic wax up 130 and stone cast 125. The design of the framework or bar can also include a unique subtract body that can be used for creating the appropriate mating surface for the overlay or in the case of this application the provisional dental restoration 300 that will rest upon the framework or bar. The mating surface can possess the appropriate spacing to allow for the addition of acrylic, resin or cement to allow for the provisional dental restoration to be attached to the bar or framework. The mating surface can also be configured to rest on portions of the framework or bar, such as the top surface, or mate on the framework or bar on only selected areas. In addition to making an intimate mating surface, the trough 236 can be designed more of a recess that has no mating with the bar but purely provides the space for the acrylic, resin or cement to attach the provisional dental restoration to the framework or bar. The trough can also include through holes or recesses 238 where the dentist will have access to any screws used in attaching framework 242 or bar 243 to the anchors 104 in the patient's mouth. As noted in application Ser. No. 15/068,423, the framework 242 or bar 243 can be fabricated out of any dental material (metal, cobalt chrome, titanium, palladium, ceramic, zirconia, lithium disilicate, emax, ceramic composite such as Lava, PMMA, PEEK, plastic, wax, or any other desirable materials) and designed on the basis of scan data derived from multiple digital sources (table-top scanning units, intra-oral scanners, CT's, touch probe, etc.). The design of the trough 236 can also be used in generating or dictating the design of the framework 242 or bar 243. On the basis of the preplanned surgical data, the implant locations are known and the trough 236 is placed in the ideal position on the basis of the contours of the diagnostic wax up and stone cast or contours of the patient's jaw bone. On the basis of this data, the framework or bar can be reverse engineered and the implant locations can be altered to best suit the clinical demands for the case.

A pre-surgical cast with analogs 124 can be generated on the basis of a surgical guide. The dentist or technician can design and fabricate the framework utilizing this pre-surgical cast, in place of stone cast 125, along with a diagnostic wax up 130 or a virtual set up, the dentist or technician can design the framework 242 or bar 243 as noted in U.S. Pat. No. 8,100,692 and application Ser. No. 15/068,423. Framework 242 and bar 243 can also be fabricated in a more traditional manner such as laser welding or casting utilizing the same pre-surgical cast.

In addition to a trough design, the dentist may prefer a series of recesses 238 to be incorporated the diagnostic wax up surface model 230 as shown in FIG. 23. Recess 238 can be cylindrical or any preferred shape that would be ideal for receiving temporary coping 206. For example, a flat wall may be included into the recess 238 to aid in orientation or positioning of temporary coping 206. The position of recesses 238 can be identified or determined based upon measurements taken from the CT and Panoramic radiographs. The position of the recesses can also be determined from surgical planning data where a surgical guide is being fabricated for the case. Also, if there are analogs 124 provided in stone cast 125 that diagnostic wax up 130 was designed on, the analog positions can be scanned directly or scanned utilizing scan bodies/alignment posts (as outlined in U.S. Pat. No. 8,100,692). In addition, the dentist can utilize an intra-oral scanner for identifying the positions of anchors 104 immediately after placement. Once the position for recesses 238 has been defined, the operator can alter or modify the design of the recesses 238 on the basis of the implant or abutment platform being planned for any particular location. If there is a large divergence of the implant locations, the operator can size the recesses slightly larger. Alternately, the operator can use a parametric CAD body reflective of the temporary coping 206 that will ultimately be attached to the provisional dental restoration 300. The parametric CAD body can be an exact duplicate of the temporary coping 206 or scaled slightly larger to create the required space necessary for composite resin, cement or acrylic used in attaching temporary coping 206 to the provisional dental restoration 300. The parametric CAD body can also have additional design aspects to aid in attaching temporary copings 206 to the provisional dental restoration, such as the addition of an access port geometry for injecting the acrylic, cement or resin used to attach the coping to the provisional dental restoration 300.

In addition to accommodating the temporary cylinder 206, the recesses 238 may be designed with an additional purpose. Recesses 238 may be intended to seat or mate with a surgical guide that was produced for placing the implants. The recess may seat over the sleeves or access holes placed into the surgical guide and aid in properly positioning the provisional dental restoration 300 relative to anchors 104. Obviously, instead of a series of recesses, a series of protrusions could also be used for this similar purpose. Where the protrusions would extend from the underside of provisional dental restoration and mate with recesses that were designed in the surgical guide.

The operator is also able to modify the gingiva contours of the diagnostic wax up surface model 230. The operator can perform a digital cutback 240 to the gingiva surfaces to allow for space where acrylic, composite or porcelains can be applied to these areas in generating the appropriate look for the gingiva contours of the provisional dental restoration 300. This digital cutback can be performed on both the buccal and lingual aspect of the diagnostic wax up surface model 230. Typically, the digital cutback 240 will reduce the original gingiva contours by 1-4 mm.

Upon finalizing the diagnostic wax up surface model 230, this file can now be used for fabricating provisional dental restoration 300. The file can be used in a number of CNC fabrication methods, including but not limited to milling, 3D printing, laser sintering, or EDM. Also the provisional dental restoration 300 can be fabricated from a number of dental materials (metal, cobalt chrome, titanium, palladium, ceramic, zirconia, lithium disilicate, emax, ceramic composite such as Lava, PMMA, PEEK, pekton (PEKK), plastic, wax, or any other biocompatible materials commonly used in dentistry). For the preferred fabrication method and material, provisional dental restoration 300 will be milled from a PMMA (polymethyl methacrylate) puck. This method and material provides a balance in strength, esthetics and an ability for the dentist to modify the provisional dental restoration 300 as he/she sees fit at the time of surgery. Preferably, the PMMA will consist of the appropriate tooth shade (A1, B1, etc.). Currently available PMMA pucks have multi layers of colors and translucency, which allows for the milled provisional dental restoration 300 to have a similar shade as the denture teeth, which have a similar number of layers of colors and translucency. The technician will be able to apply pink acrylic (another form of PMMA) or resin for the look of the gingiva for the provisional dental restoration 300 after being milled. As the acrylic and resin being used for this purpose are similar forms of polymethyl methacrylate, the bond of the pink gingiva to the milled PMMA will be quite strong and provide the appropriate esthetics for the patient.

The above disclosed invented process utilizes a traditional diagnostic wax-up 130, which provided the contours of denture teeth 132 and wax 134, which provide the contours of the gingiva portion of the provisional dental restoration 300. In the first alternate embodiment of the invented process, the use of a virtual set up is used in place of the diagnostic wax-up 130. There are currently multiple dental systems and software (such as 3Shape, Dental Wings, Avadent and Procera) which have the ability to lay in CAD models of stock denture teeth or crown CAD models relative to scans of a stone cast and an opposing dentition. For this first alternate process, the stone cast and opposing cast would be scanned separately and then scanned in their proper orientation relative to one another. Utilizing the scan capturing the orientation of the stone cast and opposing cast, the scan data of the stone cast and opposing cast will be properly aligned to one another. Once properly aligned, the Operator will position the CAD models of the stock denture teeth or crown CAD models relative to the occlusion of the opposing cast. Once the position of the CAD models of the stock denture teeth or crown CAD models have been finalized, this information can be used in creating the diagnostic wax up model 230. The technician can also add the gingiva contours or a reduction of the gingiva contours digitally to allow for the appropriate application of the acrylic or resin material as previously discussed. This process may be advantageous over the previous described process as it alleviates the dentist and/or technician from having to create the diagnostic wax up. Also, if the CAD models of stock denture teeth or crown CAD models are truly parametric, the operator can modify the design of the occlusal contours and buccal contours of the desired crown to meet any unique design requirements for the dentist.

In the second alternate process, the scanning process for capturing the implant and abutment positions is altered by the use of an intra-oral scanner that would directly capture the implant and/or abutment locations in the patient's mouth along with the gingiva contours. The intra-oral scanner can also capture the contours of a diagnostic wax up, denture or denture tooth set up that has been placed in the patient's mouth or the position and orientation of the edentulous arch relative to the opposing arch during the scanning process. From this digital data, the dentist or technician can identify the appropriate location of the implants and or abutments, CAD models of stock denture teeth or crown CAD models and trough 236 or recesses 238. This process would alleviate the dentist or technician from being required to create an impression or stone cast.

In a third alternate embodiment, the dentist or technician can utilize a CT scan or series of CT scans for the basis of determining the stone cast surface model 225 and diagnostic wax up surface model 230. The dentist or technician can use the CT scan data for determining or planning the position of the implant locations and ultimately the position of trough 236 or recesses 238. The use of a radiographic stent or guide demonstrating the ideal tooth position or gingiva contours for the provisional dental restoration or final restoration can also be included in this process and provide the dentist and technician with an ability to align CAD models of stock denture teeth or crown CAD models to the contours of the radiographic stent or relative to the position of the opposing arch. The dentist or technician could also utilize a CT scan of the patient's previous existing dentition, which could be aligned utilizing anatomical markers, in order to determine the ideal position of the CAD models of stock denture teeth or crown CAD models.

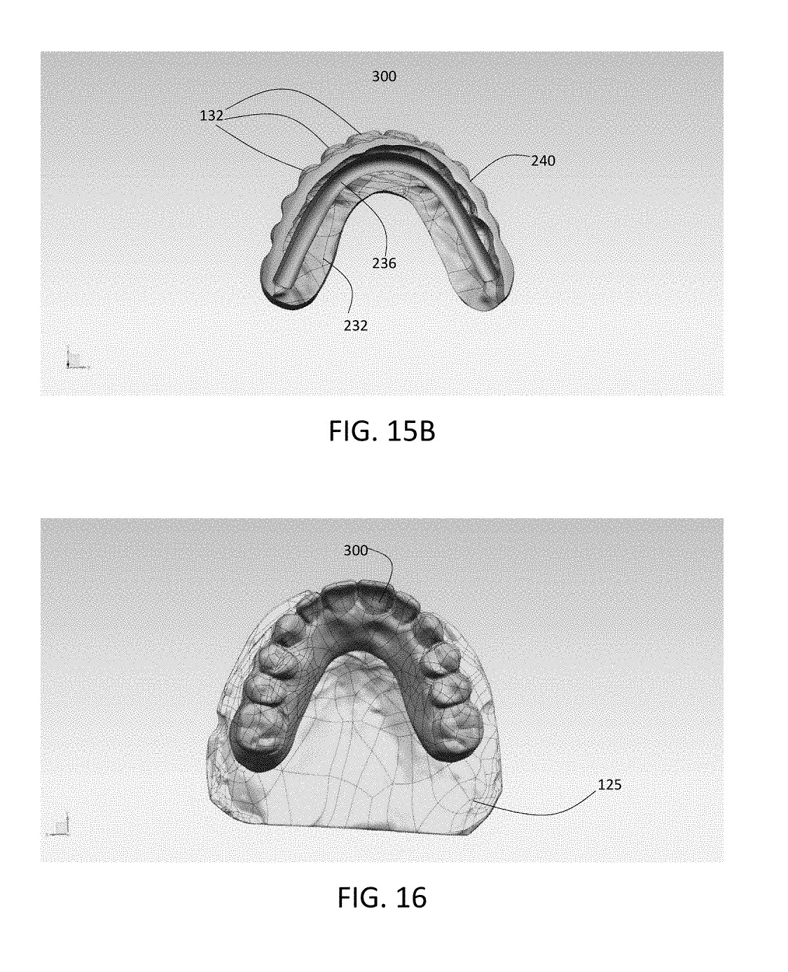

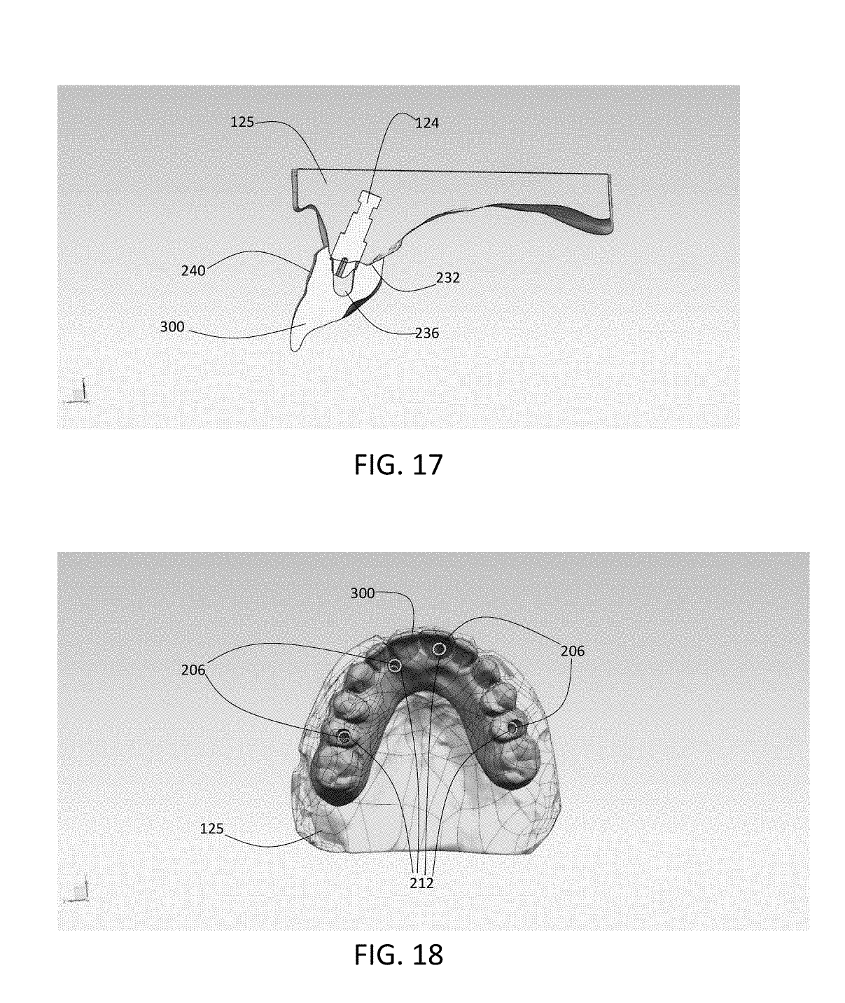

FIGS. 15A, 15B, 16 and 17 show the provisional dental restoration 300 with the trough 236. FIG. 15B shows the underside with stone cast mating surface 232 and demonstrates the denture teeth and acrylic base plate portion being designed as a single piece. FIG. 16 depicts provisional dental restoration 300 with trough 236 positioned appropriately on stone cast 125 with analogs 124. The provisional dental restoration 300 also includes a digital cutback 240 in the design. FIG. 17 shows a cross-sectional view of provisional dental restoration 300 with trough 236 properly positioned on stone cast 125 with analogs 124. The trough 236 has been positioned appropriately on the ridge and seats over analog 124.

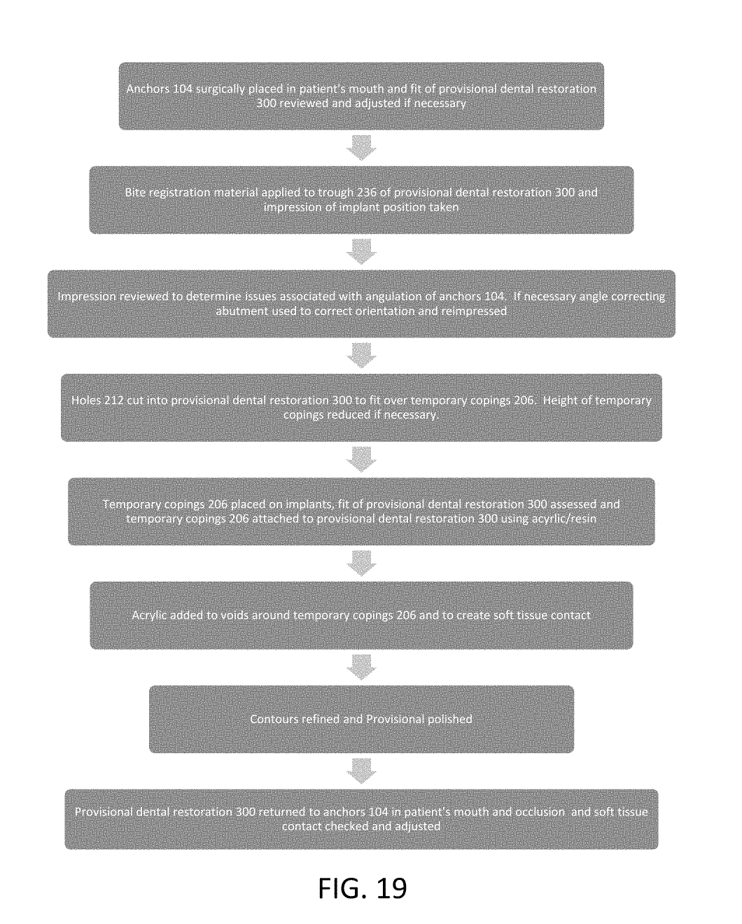

The dentist is now ready to modify provisional dental restoration 300 to receive temporary copings 206 as outlined in the flow charts provided in FIGS. 19, 20 and 21. If performing the modification chair side as outlined in FIG. 19, the dentist will review the fit of the provisional dental restoration over the implants and abutments in the patient's mouth and adjust for any interference with a hand piece. The dentist will be able to use the palatal portion or the flanges to assist in determining the appropriate positioning over anchors 104. The dentist will apply an impression material or bite registration material into trough 236. The doctor will then impress or capture the position of the anchors 104 in the patient's mouth. If necessary, the dentist may need to place healing abutments on the anchors if the mating surface is subgingival. The dentist can also use this initial impression to determine if there is going to be an issue associated with the current angle or height of anchor 104. In reviewing the impression, the doctor may choose to utilize and angle correcting abutment to prevent hole 212 from exiting though an incisal edge or buccal aspect of a tooth in an esthetic area for the case. (The dentist may also choose to place an abutment to bring the mating surface above the patient's gingiva to connect with the provisional dental restoration and final restoration.) After placing the angle correcting abutment the dentist will re-impress the locations of the anchors. On the basis of the impression left in the bite material, the dentist will cut the holes 212 into the provisional dental restoration 300 to the appropriate size. The dentist will place temporary copings 206 onto anchors 104 and review and assess the fit of provisional dental restoration 300 over temporary copings 206. If necessary, the dentist will adjust the size of the holes 212 and/or the height of temporary copings 206 to allow for provisional dental restoration 300 to fit over all temporary copings 206 in the appropriate orientation on the patient's jawbone. The dentist will again be able to use the palatal portion or the flanges to assist in determining the appropriate positioning of provisional dental restoration 300 over anchors 104 and temporary copings 206. Once properly placed and positioned, the dentist will apply a self-curing or light curing acrylic or resin into the holes 212 to attach and fixate the temporary copings 206 to the provisional dental restoration 300. The dentist will remove the provisional dental restoration 300 with the attached temporary copings 206 from the patient's mouth and review the provisional dental restoration 300 for any defects. If necessary the dentist will add additional acrylic or resin material to the provisional dental restoration 300. The dentist may also need to add acrylic to the underside of the provisional dental restoration 300 to create the appropriate level of soft tissue contact for the provisional dental restoration 300. By having a somewhat close contact of the underside of the provisional dental restoration 300 to the soft tissue, the dentist can prevent food from impacting or residing in the area of the surgical site which may be a cause for infection or improper healing. The dentist will refine any contours, such as remove the palatal portion or any flanges and polish the provisional dental restoration 300. The dentist will return the provisional dental restoration 300 to the anchors 104 in the patient's mouth and review the soft tissue contact and occlusion before allowing the patient to leave. There are challenges in performing the chair side conversion of the provisional dental restoration. The dentist has to perform this work in the patient's mouth while under sedation. The dentist may not be able to see all of the different aspects or receive feedback from the patient with regards to the feel or occlusion of the provisional dental restoration. It is always recommended for the dentist to review the provisional dental restoration and any patient feedback when performing the post-surgical visits to monitor healing of the surgical sites.

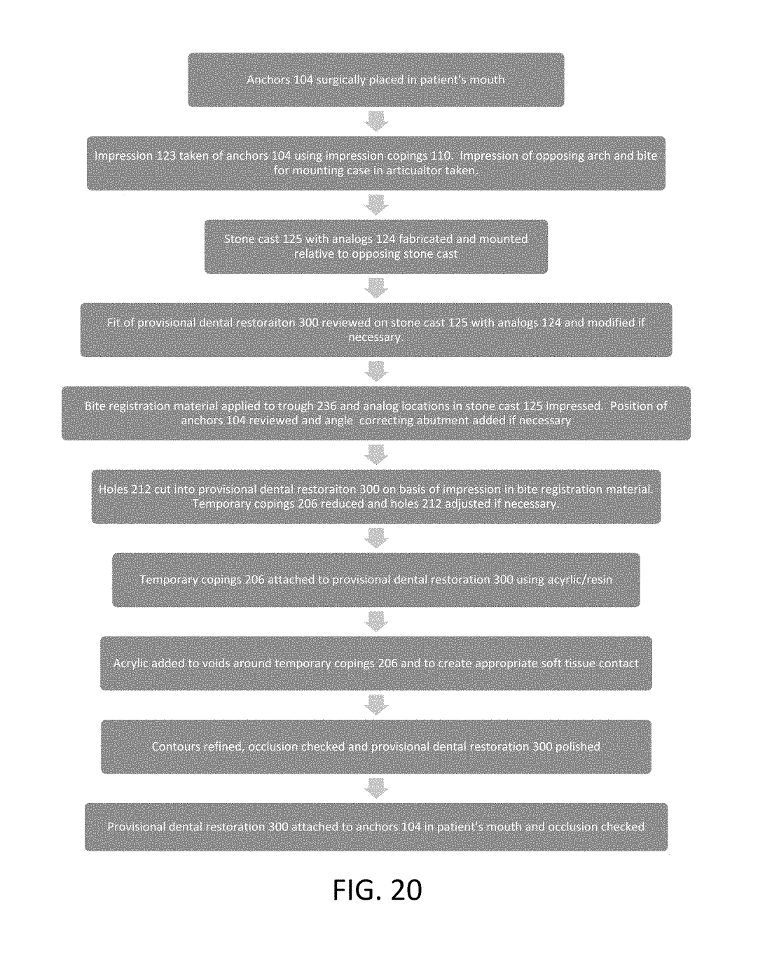

If the dentist is performing the modifications to provisional dental restoration 300 at the laboratory bench as outlined in the flow chart in FIG. 20, the process will include some additional steps. There are benefits of performing the modifications at the laboratory bench. The dentist is able to allow the sedated patient to rest and will have better access in performing the necessary modifications on a mounted stone cast. Once the anchors 104 have been surgically placed, the dentist will take an impression 123 in a similar fashion as previously noted in this application and create the stone cast 125 with analogs 124. The dentist will also impress the opposing arch and generate a stone cast of the opposing dentition. Utilizing a bite or wax bite rim, the dentist will the mount stone cast 125 with analogs 124 in an appropriate orientation with the opposing stone cast. The dentist will review the fit of provisional dental restoration 300 against the analogs 124 in stone cast 125 and the occlusion relative to the opposing stone cast. The dentist will place impression or bite registration material into trough 236 and impress the locations of the analogs. The dentist will be able to review the position of the analogs 124 and determine if there are any issues associated with the angulation of any of the anchors 104 in the patient's mouth. The dentist can choose to place an angle correcting abutment on the analog 124 on stone cast 125. The angle correcting abutment will be transferred to the anchor 104 in the patient's mouth at the time of delivering the provisional dental restoration 300. Alternately the dentist can choose to place the angle correcting abutment on the anchor 104 in the patient's mouth and create a new impression 123. The dentist will cut holes 212 into the provisional dental restoration 300 on the basis of the impression of the analogs 124 in the bite registration material added to trough 236. The dentist will attach temporary copings 206 to the analogs 124 and review the fit of the provisional dental restoration 300 on the stone cast 125 with the temporary copings 206 and the provisional dental restoration 300 properly positioned. If necessary, the dentist will adjust the holes 212 and/or the height of temporary copings 206 to allow for the appropriate seating. The dentist will apply a self-curing or light curing acrylic or resin to holes 212 to fixate temporary copings 206 to the provisional dental restoration 300. Once the acrylic and resin has cured, the provisional dental restoration 300 will be removed from stone cast 125 and checked for any voids. As necessary to fill in any voids or create the appropriate soft tissue contact, additional acrylic or resin may be added to the provisional dental restoration 300. The dentist will refine the contours of provisional dental restoration 300 (removing any flanges or palatal portion) and polish the provisional dental restoration 300. The dentist can utilize the mounted stone cast 125 and opposing stone cast to check the occlusion prior to delivering the provisional dental restoration 300 back to the anchors 104 in the patient's mouth. Again, the doctor will check the soft tissue contact and occlusion after delivering the provisional dental restoration 300 to the anchors 104 in the patient's mouth before allowing the patient to leave.

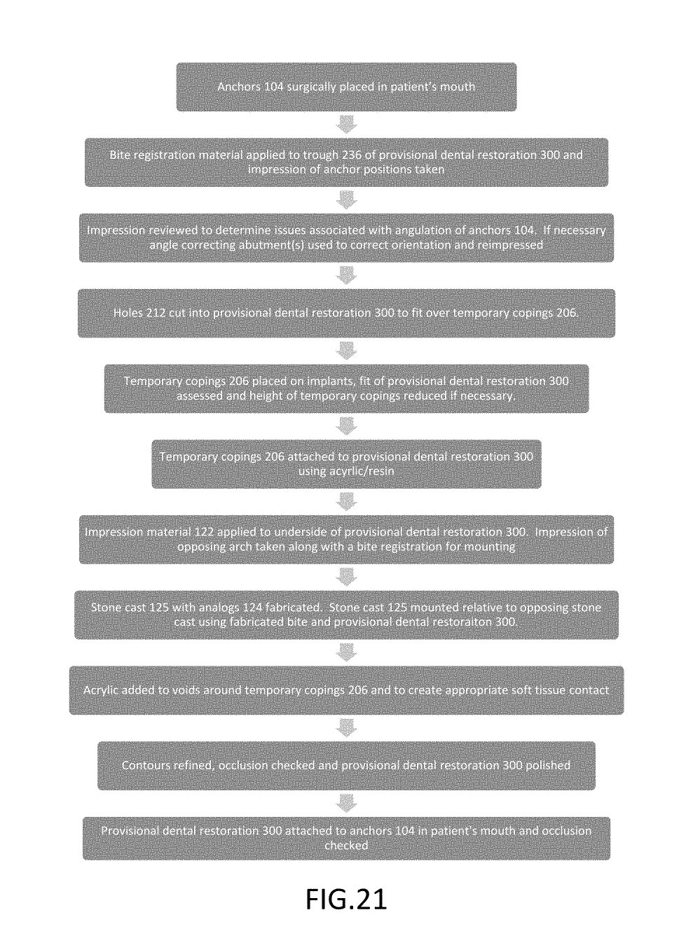

It can also be appreciated that the provisional dental restoration 300 can be used in place of the traditional impression tray 120 for the impression process and used to create stone cast 125. This process would combine the two previously described processes. After placing anchors 104, the dentist will impress the locations using the bite registration material applied to trough 236. The dentist will make the appropriate holes 212 on the basis of the impressed locations of anchors 104. The dentist will attach temporary copings 206 to provisional dental restoration 300 by applying acrylic or resin into holes 212 and allowing to harden/cure. Once the temporary copings 206 have been attached to provisional dental restoration 300, the dentist can take a bite and apply impression material to the underside of the provisional dental restoration 300 to accurately capture the soft tissue contours of the patient's mouth after the surgical process. Analogs 124 can be attached to the temporary copings 206 in the provisional dental restoration 300 and stone cast 125 can be generated. An impression of the opposing cast will also be created by the dentist and utilizing the bite taken of the provisional dental restoration 300 in the patient's mouth, stone cast 125 and opposing cast can be mounted appropriately in an articulator. Once mounted, the dentist can remove the provisional dental restoration 300 from stone cast 125, remove any residual impression material and fill any voids around temporary copings 206 and add any additional acrylic to create the appropriate level of soft tissue contact for the case. The dentist will check occlusion, refine the contours and polish the provisional dental restoration 300 before seating it on the anchors 104 in the patient's mouth. The dentist will confirm the occlusion and soft tissue contact one more time before allowing the patient to leave. This process is obviously advantageous as it prevents the requirement of using an impression tray and allows for the provisional dental restoration 300 to also double as a verification jig as discussed previously in this application and assist in mounting the case in the lab. This process also allows for the greatest speed and allows the patient to rest while additional refinement of the provisional dental restoration 300 is completed in the lab. This process has been outlined in the flow chart included in FIG. 21.

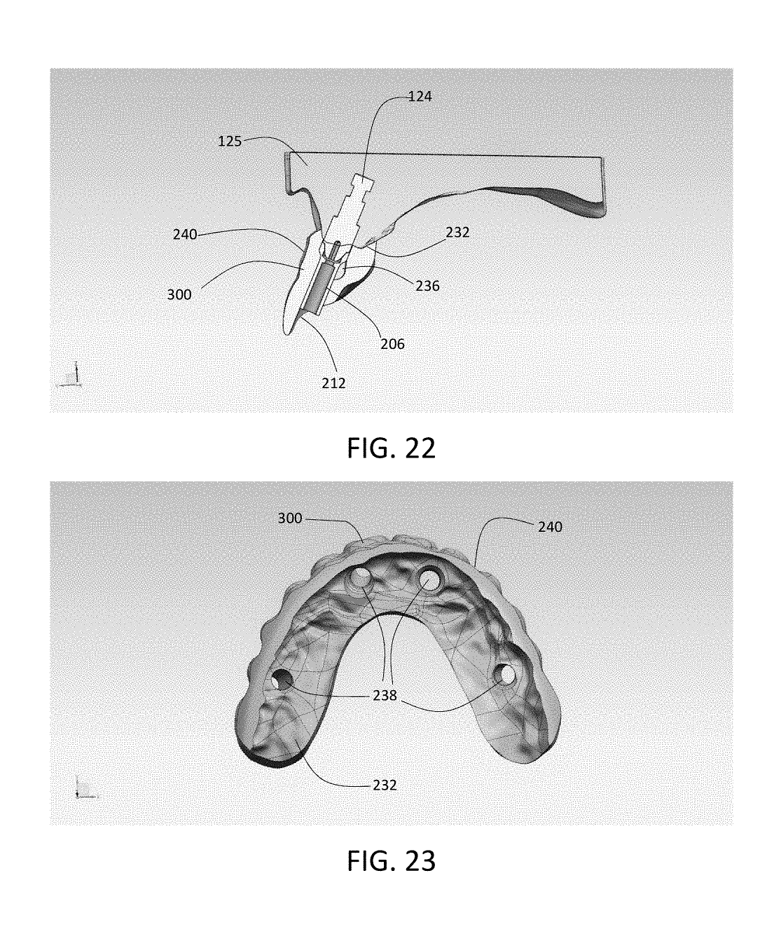

FIGS. 18 and 22 show the provisional dental restoration 300 seating on stone cast 125 with temporary copings 206 attached to the provisional dental restoration 300 through the applied acrylic in holes 212. The dentist is able to control and reduce the size of the holes 212 and retaining the maximum amount of strength for the provisional dental restoration 300. FIG. 22 shows a cross-sectional view demonstrating this aspect as well. Being able to create a refined hole 212 in provisional 300 also aids in the speed of delivering the final restoration to the patient.

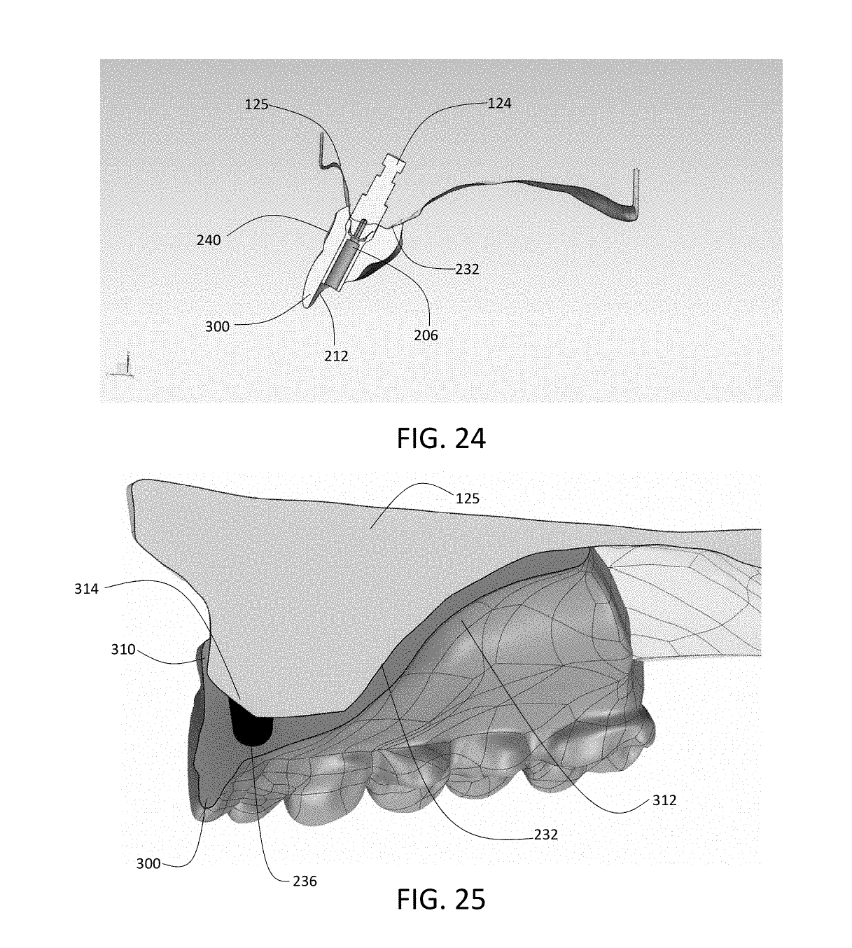

In addition to the trough design just discussed in the application, the provisional dental restoration 300 can also include a series of recesses 238 for receiving the temporary copings 206. As discussed previously, these recesses 238 can be cylindrical in nature or have any geometry deemed appropriate by the dentist or operator who designed the provisional dental restoration 300. The recesses can include flats for the purposes of positioning the temporary cylinders 206 into the recess appropriately or in positioning the provisional dental restoration 300 relative to the anchors in the patient's mouth. The recesses can be made from a parametric CAD body that is a duplicate of the temporary coping 206 or a slightly oversized version to accommodate the space for the acrylic or resin that will be sued to fixate the temporary coping 206 to the provisional dental restoration 300. The parametric CAD body can also include additional features into the design, such as a body for creating an injection port for the acrylic or resin to be injected into the recess 238 to retain a temporary coping 206. Typically, the position of these recesses is determined from digital planning for the surgical placement of the anchors 104 using a surgical guide. Alternately, this information can be derived from taking scan data of analogs 124 in the stone cast 125 or the dentist utilizing an intraoral scanner to capture the position of the anchors directly in the patient's mouth. As discussed already, this data can be incorporated into the diagnostic wax up surface model 230 and allow for an even faster process of attaching the temporary copings 206 to the provisional dental restoration 300 as these positions will have already been determined prior to surgery. FIGS. 23 and 24 shows the provisional dental restoration 300 with recesses 238 versus trough 236. For this process for the creation of the provisional dental restoration 300, the dentist may not need to impress the location of anchors 104 as previously discussed. The holes 212 in essence have already been cut for the benefit of the dentist and the temporary copings 206 will have an intimate mating within recess 238. The dentist will review and assess the fit of the provisional dental restoration 300 over the temporary copings 206 that have been attached to anchors 104 or to the analogs 124 in stone cast 125. If necessary the recesses 238 and temporary copings 206 will be adjusted with a hand piece and then the temporary copings 206 will be attached to the provisional dental restoration 300 by means of a self-curing or light cured acrylic or resin. The dentist will fill any voids, refine any contours, polish and confirm occlusion before allowing the patient to leave. The provisional dental restoration 300 with recesses 238 can also be used in a similar fashion as the provisional dental restoration 300 with trough 236 was described as being used for the purposes of creating an impression and stone cast 125 as outlined in the flow chart shown in FIG. 21.

The previous descriptions reflect a more generally used concept where temporary copings 206 have been attached to provisional dental restoration 300. The inventor has also discussed the process for the trough 236 to be designed to mate or receive a bar or framework. The process will be similar to the above mentioned process. Once the implant anchors 104 have been surgically placed, the dentist will attach framework 242 to anchors 104. The dentist will assess the fit of framework 242 on anchors 104 and the fit of provisional dental restoration 300 over framework 242 in the patient's mouth. If necessary the dentist will adjust trough 236 to provide a more appropriate fit over framework 242. The dentist will impress the position of framework 242 and identify the position of any screw access holes associated with framework 242. The dentist will make the appropriate holes 212 on the basis of the impressed locations of the screw access holes. Alternatively if recesses 238 have been included in the design of the trough 236, the dentist will review the ability to access the screws in the screw access holes to ensure no adjustments are required. The dentist will attach framework 242 to the provisional dental restoration 300 by means of a self-curing or light cured acrylic or resin. The dentist will fill any voids, refine any contours, polish and confirm occlusion before allowing the patient to leave. If preferred, the dentist may also choose to impress the soft tissue and create a bite once framework 242 has been attached to provisional dental restoration 300 in order to create stone cast 125 with analogs 124. This process would enable the dentist to complete any of the finishing work in the lab and allow for the case to be mounted in preparation for completing the final prosthesis.

The benefits of abutment selection have been covered already with the use of the trough 236 in the provisional dental restoration 300, but there is a second surgical benefit that can be included in the design of the provisional dental restoration 300. Determining or confirming the appropriate level of bone reduction can be challenging. Many times, dentists review and take measurements from their CT and Panoramic radiographs. However, at the time of surgery, dentists can lose their point of reference in performing the required bone reduction or in the worst cases not reduce enough bone for the required prosthesis. In these instances, the dentist has to make accommodations in the final restoration to overcome this lack of bone reduction. It may require a different type of restoration being provided to the customer or potentially schedule a second surgery to further reduce the bone to obtain the necessary space for the restoration. In order to confirm or guide the dentist in ensuring the appropriate level of reduction has been performed, the provisional dental restoration 300 can exhibit a properly sized buccal flange 310 designed on the basis of measurements, radiographic stents or CT data incorporated into the design of the diagnostic wax up surface model 230 and ultimately the provisional dental restoration 300. The height of the flange can be reviewed against the reduced bone to confirm the reduction has been performed appropriately. Also, the flange can be used in performing the bone reduction itself. Once the soft tissue has been reflected, the provisional dental restoration 300 can be placed in the patient's mouth and properly positioned using the flanges and or palatal portions. The dentist can use a surgical instrument to mark the bone around the buccal aspect of the arch using the height of the flange as a guide. Once the markings have been made, the provisional dental restoration 300 can be removed and the bone reduction can be performed by the dentist. Alternatively marking the bone can be done prior to flapping the tissue by perforating the bone through the tissue utilizing the height of the flange. If so desired, the buccal flange 310 can also be designed with markings that denote different heights relative to the occlusal plane of the provisional dental restoration 300, which can allow the dentist to quickly assess the bone height and potential reduction that can be performed for a patient.

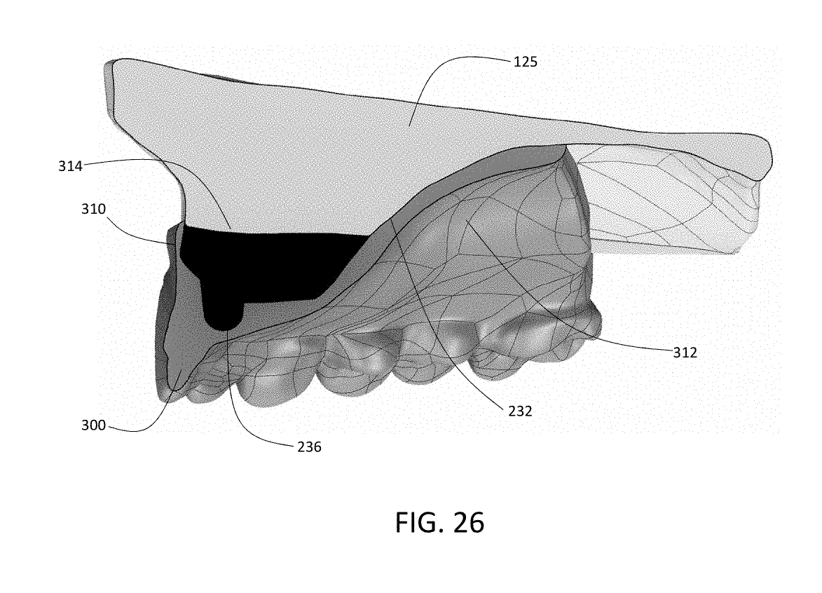

FIGS. 25 and 26 demonstrate the use of the provisional dental restoration 300 and buccal flange 310 in either performing or confirming the level of bone reduction. In FIG. 25 the provisional dental restoration 300 is seating on the stone cast 125. The provisional dental restoration 300 has the stone cast mating surface 232 engaging the contours of stone cast 125 with palatal portion 312. As demonstrated by the image the buccal flange 310 has been designed to the appropriate height on the basis of a planned reduction. The crest of the ridge 314 is extending towards the teeth beyond the height of the buccal flange 310. In FIG. 26 the crest of the ridge 314 has been reduced to match the height of the buccal flange 310. The palatal portion 312 still maintains a substantial amount of the stone cast mating surface 232, which will allow for the provisional dental restoration 300 to be appropriately positioned on stone cast 125 and on the patient's jawbone at the time of surgery.

In addition to confirming abutment selection and bone reduction, the provisional dental restoration 300 allows for the dentist to confirm a number of attributes or features that may need to be maintained or altered for the final prosthesis. During the healing phase, the dentist and the patient have the ability to review the vertical dimension, tooth and gingiva shade, occlusion, midline position, lip support, canine position, canine guidance, overall esthetics, plane of occlusion, tooth shape and contours, gingiva contours and soft tissue contact. This process can be especially important for patients who want to achieve a particular look or level of function for the final prosthesis. The dentist can note any requested modifications and photo document the provisional dental restoration 300 in the patient's mouth to provide insight to the laboratory who will be fabricating the final prosthesis.

The provisional dental restoration 300 described in this application has some unique design features that provide improved performance characteristics and additional tools that can be helpful to the dentist at the time of surgery and in preparation for the final prosthesis. The second embodiment of the invention is using a duplicate or slightly altered version of the provisional dental restoration 300 in the impression process for the final prosthesis.

The provisional dental restoration 300 was designed to provide an appropriate interim prosthesis during the healing process for the patient. A tremendous amount of time and effort was spent to create the appropriate vertical dimension, tooth and gingiva shade, occlusion, midline position, lip support, canine position, canine guidance, overall esthetics, plane of occlusion, tooth shape and contours, gingiva contours and soft tissue contact. The dentist also spent a tremendous amount of time in delivering the provisional dental restoration 300 to the anchors placed in the patient's mouth. In the traditional fashion, the entire process of impressing, creating inter occlusal records, creating a stone cast, fabricating a verification jig, creating a diagnostic wax up as discussed earlier in the application is started over again once healing is complete. The provisional dental restoration is removed and the anchor positions are impressed with traditional impression copings. A verification jig is fabricated on the resulting stone cast and the stone cast with analogs and opposing cast are mounted on the basis of the inter occlusal records taken at the time of impression. A new diagnostic wax up 130 is created and again tried in the patient's mouth and the position and design of the teeth and gingiva are reviewed with the patient. This process takes multiple visits and delays the time in which the patient can receive the final restoration. In the flow chart shown in FIG. 21, the inventor describes the use of the provisional dental restoration 300 to create an impression of the anchors 104 in the patient's mouth. There is no reason why an additional provisional dental restoration 300 can't be used to perform a similar impression process when the dentist is ready to fabricate the final prosthesis. In order to differentiate between the process for the creation of the first provisional dental restoration and process for the creation of the second provisional dental restoration, the second provisional dental restoration will hereafter be called an “impression prosthesis”.

As noted previously in the application, the dentist has the ability to create an impression 123 of the anchors 104 either using an impression tray 120 or provisional dental restoration 300. The impression tray 120 is usually a stock plastic tray with no attributes that would aid in determining an appropriate shade, vertical dimension or occlusal scheme for the case. With the traditional process, the dentist still has to create diagnostic wax up 130 with denture teeth 132 to ensure the mock up for the provisional dental restoration or final restoration is acceptable for the patient. By utilizing the impression prosthesis 320 (which is a duplicate or revised version of provisional dental restoration 300), the dentist can capture all of the necessary soft tissue contours, anchor positions, occlusal scheme, position of midline, review overjet and overbite, centric relation to the opposing arch and vertical dimension or restorative space for the case.

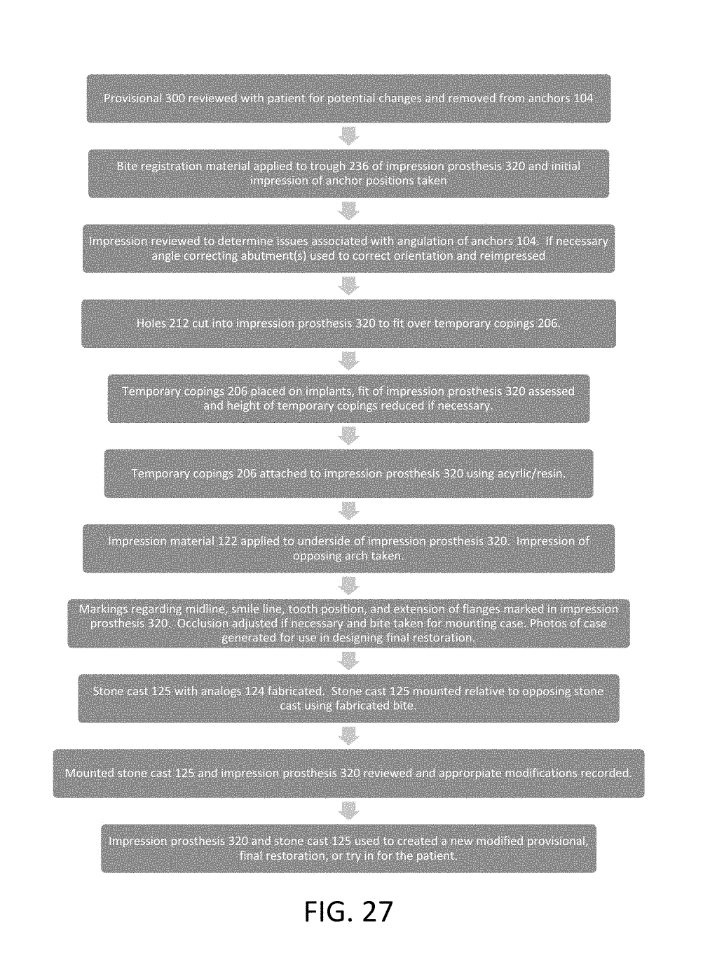

The impression prosthesis 320 as disclosed here will be manufactured in a similar fashion (milling, 3D printing, laser sintering, or EDM) and dental material (metal, cobalt chrome, titanium, palladium, ceramic, zirconia, lithium disilicate, emax, ceramic composite such as Lava, PMMA, PEEK, pekton (PEKK), plastic, wax, or any other biocompatible desirable materials) as the previously described provisional dental restoration (preferably milled from a tooth colored PMMA). The impression prosthesis 320 can consist of the same design, size, and position of the teeth incorporated into the design of the provisional dental restoration 300, but also the impression prosthesis 320 can be refined on the basis of patient feedback or clinical observations from the dentist. One example of refining the design would be changing the size or contours of the teeth. The dentist can modify the original diagnostic wax up 130 by replacing the original teeth with ones that the patient finds more suiting for their appearance. This process is even faster if a virtual diagnostic wax up or denture tooth set up was used, where the operator can refine any of the tooth position, contours, etc. The dentist has the ability to modify any of the following from the design of the provisional dental restoration 300 to the impression prosthesis; vertical dimension, tooth and gingiva shade, occlusion, midline position, lip support, canine position, canine guidance, overall esthetics, plane of occlusion, tooth shape and contours, gingiva contours and soft tissue contact. The impression prosthesis will be used in the same fashion as described in the flow chart for FIG. 21. The dentist will assess provisional dental restoration 300 with the patient for any potential changes or modifications they would like to see in the final restoration (change in shade, repositioning of teeth, shift in midline, etc.). The provisional dental restoration 300 will be removed and the fit of the impression prosthesis 320 over anchors 104 will be assessed. If necessary the impression prosthesis will be adjusted. If performing this process with a trough design, bite registration material will be applied to trough 236 and an initial impression of the anchor positions will be taken and appropriate holes 212 will be cut into the impression prosthesis. If performing the process with a recess design, the fit of the impression prosthesis 320 over anchors 104 will be assessed and adjusted if necessary. The temporary copings 206 will be attached to anchors 104 and attached to the impression prosthesis 320 with a self-curing or light curing acrylic or resin. Impression material 122 will be applied to the underside of impression prosthesis 320. If necessary the impression material 122 can extend farther into the palatal portion of the jaw bone or into the depth of the vestibules to capture more of the edentulous ridge. An impression of the opposing arch and bite can be taken to allow for appropriate mounting of the case into an articulator. At this time the dentist can now make any markings or photo documentation associated with the case. The dentist can mark the high smile line or shift in the midline. The dentist can adjust the occlusion or measure the overbite and overjet associated with the case. The dentist can take photographs with available shade tabs to denote a change in color preference by the patient. The dentist can review the incisal display or requirements regarding the gingiva contours (lip support). The dentist will also take a series of inter occlusal records, i.e., a bite for mounting the case properly. The dentist can also choose to utilize a face bow for taking these inter occlusal records. Once the dentist has performed all of the required diagnoses for the final restoration, the dentist can remove the impression prosthesis from the anchors. Analogs 124 can be attached to the temporary copings 206 and a stone cast 125 for the final restoration can be created. It should also be noted that the impression prosthesis 320 can serve as the verification jig as mentioned previously in the application. Once the stone cast 125 has been produced and the case mounted in the articulator, the dentist can perform any requested or required adjustments to the impression prosthesis as reviewed with the patient. Since the impression prosthesis has been fabricated from PMMA, modifications can be easily performed by the dentist or technician. The teeth and gingiva portion of the impression prosthesis 320 can be reduced or removed entirely and new denture teeth and refined gingiva contours (using wax or acrylic) can be created to provide the patient with a newly refined mockup of the proposed final prosthesis. Alternately, the impression prosthesis can be scanned and used to create or adjust the original digital wax up or set up for the patient digitally. The modifications can be used to fabricate another provisional dental restoration 300 for the patient to wear and review for a period of time or the design modifications can be incorporated into the final restoration. As mentioned previously, the dentist has the ability to review the state of the current provisional dental restoration 300 during the healing stage follow up visits with the patient and make any adjustments to the digital set up or modify the impression prosthesis on the basis of the patient's feedback prior to performing the final impression after healing. The process for creating the stone cast 125 using the impression prosthesis 320 has been outlined in a flow chart in FIG. 27.

By improving the process for delivering the provisional dental restoration 300 and generating the impression and occlusal records for the final restoration, the dentist will be able to deliver the final prosthesis in a shorter amount of time and with improved confidence. The overall experience for the patient will be improved as well. They will be able to receive the final restoration in a shorter time frame and alleviate unnecessary or unplanned visits.

What is claimed is:

1. A provisional dental restoration and a plurality of implants and abutments to which the provisional dental restoration mates, wherein the provisional dental restoration comprises:
a design of the provisional dental restoration that includes a tooth and base plate portion designed into a single structure;
a series of recesses positioned on the intaglio surface of the provisional dental restoration;
wherein the position of the series of recesses is determined from digital data defining the patient's current or planned clinical condition;
wherein the series of recesses are designed with the use of a series of unique subtract bodies;
wherein the design of the provisional dental restoration is determined from digital data defining the appropriate tooth and gingiva contours for the provisional dental restoration;
wherein the provisional dental restoration is manufactured from a dental material.

2. The provisional dental restoration of claim 1, wherein the digital data defining the appropriate tooth and gingiva contours is derived from at least one of scanning a diagnostic wax up, existing denture or denture tooth set up; a virtual set up where tooth or crown CAD models have been aligned digitally; an intraoral scan of a diagnostic wax up, existing denture or denture tooth set up taken in the patient's mouth; a CT scan or series of CT scans of the patient's mouth; and a CT scan or series of CT scans with the use of a radiographic stent or guide in the patient's mouth.

3. The provisional dental restoration of claim 1, where in the digital data used in determining the position of a series of recesses is derived from at least one of scanning a diagnostic wax up, existing denture or denture tooth set up; a virtual set up where tooth or crown CAD models have been aligned digitally; an intraoral scan of a diagnostic wax up, existing denture or denture tooth set up taken in the patient's mouth; a CT scan or series of CT scans of the patient's mouth; a CT scan or series of CT scans with the use of a radiographic stent or guide in the patient's mouth; scanning the analogs in the stone cast of the patient; an intraoral scan of the plurality of implants and abutments in the patient's mouth; digital surgical planning of the proposed implant positions on the basis of a CT scan or series of CT scans.

4. The provisional dental restoration of claim 1, where the series of subtract bodies used in creating the series of recesses are fully parametric and easily edited during the design phase.

5. The provisional dental restoration of claim 1, where the design of a series of recesses consists at least one of a singular trough, a series of cylindrical recesses, a singular trough with a series of cylindrical recesses, a geometry matching the contours of the coping it's intended to receive, a geometry slightly larger than the contours of the coping it's intended to receive, a geometry matching the contours of a dental implant bar or dental implant framework, a geometry intended to mate with portions of a dental implant bar or dental implant framework, a geometry slightly larger than the contours of a dental implant bar or dental implant framework.

6. The provisional dental restoration of claim 1, where the gingiva structures of the prosthesis can be constructed out of at least one of wax, acrylic, porcelain, ceramic or resin material.

7. The provisional dental restoration of claim 1, where the provisional dental restoration is used at the time of surgery to select an appropriate abutment for an implant.

8. The provisional dental restoration of claim 1, where the provisional dental restoration is used to perform a ridge reduction or confirm an appropriate ridge reduction has been performed prior to placing the implants.

9. The provisional dental restoration of claim 1, where the provisional dental restoration is used to confirm at least one of vertical dimension, tooth shade, gingiva shade, occlusion, lip support, esthetics, midline position, canine position, canine guidance, plane of occlusion, soft tissue contact, soft tissue contours.

10. A method for designing and fabricating a provisional dental restoration intended to mate with a series of implants and/or abutments in a patient's mouth comprising:
providing digital data of the gingiva contours in the patient's mouth;
providing digital data of the tooth orientation or to determine the tooth orientation for the proposed provisional dental restoration;
designing a base plate portion intended to intimately contact the patient's gingiva;
providing the gingiva contours for the proposed provisional dental restoration;
designing a series of recesses on the intaglio surface of the provisional dental restoration;
combining the digital data of the tooth orientation, base plate portion and/or gingiva contours to define the final CAD model of the provisional dental restoration; and
exporting the CAD model of the provisional dental restoration to be manufactured.

11. The method of claim 10, where in the digital data defining the gingiva contours in the patient's mouth is derived from at least one of scanning a stone cast, an intraoral scan of a patient's mouth, a CT scan or series of CT scans of the patient's mouth, and a CT scan or series of CT scans with the use of a radiographic stent in the patient's mouth.

12. The method of claim 10, where in the digital data defining the tooth orientation or used to determine the tooth orientation is derived from at least one of scanning a diagnostic wax up, existing denture or denture tooth set up, the alignment of tooth CAD models in a virtual set up, an intraoral scan of a diagnostic wax up or denture tooth set up taken in the patient's mouth, a CT scan or series of CT scans of the patient's mouth, and a CT scan or series of CT scans with the use of a radiographic stent in the patient's mouth.

13. The method of claim 10, where the tooth and base plate portion are united into a single body.

14. The method of claim 10, where the design and orientation of a series of recesses is derived from at least one of scan data of analogs in a stone cast, intraoral scans of implants and or abutments in a patient's mouth, a CT scan or series of CT scans of the patient's mouth, a CT scan or series of CT scans with the use of a radiographic stent in the patient's mouth, surgical planning data on the basis of a CT scan or series of CT scans,

15. The method of claim 10, where in the design of a series of recesses consists at least one of a singular trough, a series of cylindrical recesses, a singular trough with a series of cylindrical recesses, a geometry matching the contours of the coping it's intended to receive, a geometry slightly larger than the contours of the coping it's intended to receive, a geometry matching the contours of a dental implant bar or dental implant framework, a geometry intended to mate with portions of a dental implant bar or dental implant framework, a geometry slightly larger than the contours of a dental implant bar or dental implant framework.

16. The method of claim 10, where the provisional dental restoration is manufactured from at least one of PMMA (polymethyl methacrylate), PEEK, PEKK, plastic, titanium or other metallic materials, Zirconia or other ceramic materials, ceramic-composite materials, acrylic or other composite materials, and a biocompatible material.

17. The method of claim 10, where the provisional dental restoration is manufactured by at least one of milling, 3D printing, laser sintering, or EDM.
